(19) United States
(12) Patent Application Publication
(10) Pub. No.: US 2022/0106060 A1
(43) Pub. Date: Apr. 7, 2022

(54) HEALTH ASSESSMENT AND MONITORING SYSTEM AND METHOD FOR CLEAN FUEL ELECTRIC VEHICLES

(71) Applicant: Alakai Technologies Corporation, Stow, MA (US)

(72) Inventors: Brian D. Morrison, Hopkinton, MA (US); Glenn Austin, Marlborough, MA (US); William Spellane, Worcester, MA (US)

(21) Appl. No.: 17/494,554

(22) Filed: Oct. 5, 2021

Related U.S. Application Data
(60) Provisional application No. 63/087,632, filed on Oct. 5, 2020.

(51) Int. Cl. B64F 5/60; H01M 8/0438; H01M 8/04664; H01M 8/04537; H01M 8/0432; H01M 8/04492

(52) U.S. Cl. CPC B64F 5/60; H01M 8/0438; H01M 8/04664; H01M 8/04544; H01M 2250/20; H01M 8/04604; H01M 8/04358; H01M 8/04492; H01M 8/04574

(57) ABSTRACT

System and method for fuel-cell and motor trend monitoring including recording signals from fuel-cell and motor system-condition sensors or sets of onboard sensors and periodically analyzing results to examine fuel-cell and motor system performance trends to predict the need for fuel-cell or motor system maintenance. Various analyses can be performed, separately or in parallel, including: comparing the current parameter values with recorded parameter values in previous instances of similar operating conditions; comparing parameter values to predetermined nominal ranges; and detecting sensed parameter values that exceed recommended fuel-cell or motor system operating conditions or that exhibit trends over time that if continued result in exceeding fuel-cell or motor system operating conditions or producing out-of-bound readings. Results of the analyses inform fuel-cell, motor, and aircraft system maintenance scheduling and provide alerts to users regarding recommended fuel-cell, motor, and aircraft system performance trends and/or operating condition exceedances, enhancing safety and improving maintenance efficiency.

### CROSS-REFERENCE TO RELATED APPLICATION(S)

This application claims priority to, and the benefit of, co-pending U.S. Provisional Application 63/087,632, filed Oct. 5, 2020, for all subject matter common to both applications. The disclosure of said provisional application is hereby incorporated by reference in its entirety.

### FIELD OF THE INVENTION

The present invention is directed to a system and method for health assessment, monitoring, operation, and maintenance of fuel-cells (“fuel-cells”) and electric motors (“motors”). It finds particular, although not exclusive, application to on-board fuel-cell powered electric (low or no emission) aircraft, including a lightweight, high power density, single or fault-tolerant fuel-cell for a full-scale, clean fuel, electric-powered vertical takeoff and landing (eVTOL) multirotor aircraft, or fixed wing or hybrid aircraft, including Advanced Air Mobility (AAM) aircraft, where the fuel-cell modules or other on-board sources of power transforms hydrogen and oxygen or other suitable energy-storage materials into electricity that is then used to operate one or more electric motors, depending upon the application and architecture. By using the results of the measurements of sensors and components to inform computer monitoring, the system, method and apparatus can use data related to both fuel supply subsystems and power generating subsystems to improve aircraft function, reliability, safety, and efficiency. The aircraft may be operated in unmanned aerial vehicle (UAV) or drone mode following either remote commands or a pre-programmed route to its destination, or it may be operated by a pilot in operator mode.

### BACKGROUND

Although reduced scale multirotor aircraft (sometimes called multi-copters) are not new, they have been reduced scale models not intended for the rigors or requirements of carrying human passengers, and are mostly used either as toys, or for limited-duration surveillance or aerial photography missions with motion being controlled by radio-control remotes, or for flying pre-planned routes. Most if not all are battery powered. For example, US Patent Application 20120083945 relates specifically to a reduced scale multi-copter, but does not address the safety, structural, or redundancy features necessary for an FAA-certified passenger-carrying implementation, nor any of the systems required to implement a practical, passenger-carrying vehicle with fault-tolerance and state-variable analysis, nor any way of generating its own power from fuel carried on-board. The dynamics and integrity requirements of providing a full-scale aircraft capable of safely and reliably carrying human passengers and operating within US and foreign airspace are significantly different that those of previous reduced scale models and require more sophisticate components, sensors, assessment systems and monitoring devices.

A large volume of personal travel today occurs by air. For destinations of more than 500 miles, it has historically been the fastest travel mode and, in terms of injuries per passenger mile, the safest. However, only about 200 hub and spoke airports exist within the US, placing much of the population more than 30 minutes away from an airport. Yet there are over 5,300 small control-towered regional airports, and over 19,000 small airfields with limited or no control towers throughout the US, placing more than 97% of the population within 15 to 30 minutes of an airfield. As many have noted before, this is a vastly under-utilized capability.

In the 21st Century, the opportunity is available to apply advanced technologies of the evolving National Airspace System (NAS) to enable more-distributed, decentralized travel in the three-dimensional airspace, leaving behind many of the constraints of the existing hub-and-spoke airport system, and the congestion of the 2-dimensional interstate and commuter highway systems.

Many large cities and metropolitan areas are virtually gridlocked by commuter traffic, with major arteries already at or above capacity, and with housing and existing businesses posing serious obstacles to widening or further construction. NASA, in its ‘Life After Airliners’ series of presentations (see Life After Airliners VI, EAA AirVenture 2003, Oshkosh, Wis. Aug. 3, 2003, and Life After Airliners VII, EAA AirVenture 2004, Oshkosh, Wis. Jul. 30, 2004) and NASA's Dr. Bruce Holmes (see Small Aircraft Transportation System—A Vision for 21st Century Transportation Alternatives, Dr. Bruce J. Holmes, NASA Langley Research Center. 2002) make the case for a future of aviation that is based on the hierarchical integration of Personal Air Vehicles (PAV), operating in an on-demand, disaggregated, distributed, point-to-point and scalable manner, to provide short haul air mobility. Such a system would rely heavily on the 21st century integrated airspace, automation and technology rather than today's centralized, aggregated, hub-and-spoke system. The first, or lowest tier in this hierarchical vision are small, personal Air Mobility Vehicles or aircraft, allowing people to move efficiently and simply from point-to-any-point, without being restricted by ground transportation congestion or the availability of high-capability airports. Key requirements include vehicle automation, operations in non-radar-equipped airspace and at non-towered facilities, green technologies for propulsion, increased safety and reliability, and en-route procedures and systems for integrated operation within the National Airspace System (NAS) or foreign equivalents. Ultimate goals cited by NASA include an automated self-operated aircraft, and a non-hydrocarbon-powered aircraft for intra-urban transportation. NASA predicts that, in time, up to 45% of all future miles traveled will be in Personal Air Vehicles.

Therefore, a full scale multi-copter implementation that finds applications for commuting, for recreation, for inter-city transportation, for industrial, for delivery, or for security and surveillance applications among others with or without human passengers on board, based on state-of-the-art electric motor and electronics and computer technology with high reliability, safety, simplicity, and redundant control features, with on-board capability to generate its own electrical power (as opposed to simply consuming energy previously stored in electro-chemical batteries), coupled with advanced avionics and flight control techniques is described.

Existing reduced scale multirotor aircraft (sometimes called multi-copters) have been reduced scale models not intended for the rigors or requirements of carrying human passengers. As a result, these devices generally rely upon simplistic power production systems that include basic batteries, heat sinks, and electric motors but lack the radiators, fluids (often referred to as coolant), cooling fans, or monitoring devices for cooling systems that passenger carrying powered vehicles commonly provide. They also lack the sophisticated sensors and vehicle health assessment and monitoring systems necessary to meet the requirements of carrying human passengers (while economizing space and weight devoted to such systems to accommodate dimensional requirements significantly smaller than conventional aircraft). The significant dynamics and integrity requirements of providing a full-scale aircraft capable of safely and reliably carrying human passengers are significantly different that those of reduced scale models. Although such requirements have contributed to the high level of safety that the flying public enjoys, that safety has come at a cost. And this cost is particularly evident in relatively low-volume, short-distance routes. Air travel by major commercial carriers between lower-population locales has tended to be limited or unavailable since such routes can be supported most cost-effectively by small aircraft in, e.g., “air-taxi” or “air-cab” services. Although such services are beginning to be deployed in the United States, the dynamics and integrity requirements of providing a full-scale aircraft capable of safely and reliably carrying human passengers and operating within US and foreign airspace are significant. Such a vehicle requires state-of-the-art electric motors, electronics and computer technology with high reliability, safety, simplicity, structural, and redundant control features necessary for FAA-certified passenger-carrying implementations, with on-board capability to generate electrical power, coupled with advanced avionics and flight control techniques using monitoring devices and assessment systems required to implement a practical, passenger-carrying vehicle with fault-tolerance and state-variable analysis.

Generating and distributing electrical power aboard aircraft (e.g. from one or more fuel-cells to one or more motors or motor controllers) presents several challenges including inefficient performance, consumption of resources, waste heat generation and dissipation rates, fatigue and wear from high velocity components or frequent repeated use, damage and degradation from exteriors environments or weather, system complexity related to maintenance, errors and failures, and constraints related to space, weight, aerodynamics, pollution, greater cost, greater weight or space consumption, restrictions on vehicle configuration, and unwanted vehicle component complexity and redundancy and safety, requiring a more efficient method to implement the relevant electromagnetic, chemical reaction, and thermodynamic principles in a variety of settings and conditions to achieve viable flight performance. Generating electrical power using a fuel-cell is an attractive alternative, but the demands of aircraft make current fuel-cell technology difficult to implement in a practical manner. Generally, a fuel-cell is an electrochemical cell of a variety of types that converts the chemical energy of a fuel and an oxidizing agent into electricity directly through chemical reactions, most often, a pair of redox reactions. Two chemical reactions in a fuel-cell occur at the interfaces of three different segments or components: the electrolyte and two electrodes, the negative anode and the positive cathode respectively. A fuel-cell consumes the fuel with the net result of the two redox reactions producing electric current which can be used to power electrical devices, normally referred to as the load, as well as creating water or carbon dioxide and heat as the only other products. A fuel, for example hydrogen, is supplied to the anode, and air is supplied to the cathode. A catalyst at the anode causes the fuel to undergo oxidation reactions that generate ions (often positively charged hydrogen ions or protons) and negatively charged electrons, which take different paths to the cathode. The anode catalyst, usually fine platinum powder, breaks down the fuel into electrons and ions, where the electrons travel from the anode to the cathode through an external circuit, creating a flow of electricity across a voltage drop, producing direct current electricity. The ions move from the anode to the cathode through the electrolyte. An electrolyte that allows ions, often positively charged hydrogen ions (protons), to move between the two sides of the fuel-cell. The electrolyte substance, which usually defines the type of fuel-cell, and can be made from a number of substances like potassium hydroxide, salt carbonates, and phosphoric acid. The ions or protons migrate through the electrolyte to the cathode. At the cathode, another catalyst causes ions, electrons, and oxygen to react. The cathode catalyst, often nickel, converts ions into waste, forming water as the principal by-product. Thus, for hydrogen fuel, electrons combine with oxygen and the protons to produce only generated electricity, water and heat.

Fuel-cells are versatile and scalable and can provide power for systems as large as power stations or locomotives, and as small as personal electronic devices or hobby drones. The fuel and the electrolyte substance define the type of fuel-cell. A fuel-cell uses the chemical energy of hydrogen or another fuel to cleanly and efficiently produce electricity. Fuel-cells create electricity chemically, rather than by combustion, so they are not subject to certain thermodynamic laws that limit a conventional power plant (e.g. Carnot Limit). Therefore, fuel-cells are most often more efficient in extracting energy from a fuel than conventional fuel combustion. Waste heat from some cells can also be harnessed, boosting system efficiency still further.

Some fuel-cells need pure hydrogen, and other fuel-cells can tolerate some impurities, but might need higher temperatures to run efficiently. Liquid electrolytes circulate in some cells, which require pumps and other additional equipment that decreases the viability of using such cells in dynamic, space restricted environments. Ion-exchange membrane electrolytes possess enhanced efficiency and durability at reduced cost. The solid, flexible electrolyte of Proton Exchange Membrane (PEM) fuel-cells will not leak or crack, and these cells operate at a low enough temperature to make them suitable for vehicles. But these fuels must be purified, therefore demanding pre-processing equipment such as a “reformer” or electrolyzer to purify the fuel, increasing complexity while decreasing available space in a system. A platinum catalyst is often used on both sides of the membrane, raising costs. Individual fuel-cells produce only modest amounts of direct current (DC) electricity, and in practice, require many fuel-cells assembled into a stack. This poses difficulties in aircraft implementations where significant power generation is required but space and particularly weight must be minimized, requiring a more efficient method to implement the relevant chemical reaction, electromagnetic, and thermodynamic principles in a variety of settings and conditions to achieve viable flight performance.

Generally, powered vehicles need to manage vibrations and dissipate waste heat from various systems and subsystems those vehicles use, including heat and wear from the friction of moving parts and heat from electrical resistance. For example, in motors, a rotor can include permanent magnets that generate a magnetic field. That magnetic field interacts with currents flowing within the windings of the stator core (made up of stacked laminations) to produce a measurable torque between the rotor and stator, resulting in rotation. As the rotor rotates, magnitude and polarity of the stator currents are continuously varied such that torque remains near constant and conversion of electrical to mechanical energy is efficient, with current control performed by an inverter. This rotation of the rotor and conversion of energy create heat, and heated parts increase physical dimensions, leading to added friction in contacting and rotating parts, adding more heat and wear. The power supplies of are subject to electrical resistance, so extra heat is produced that may be detrimental to the function of the device. Heat also increases current resistance impacting efficiency, where greater resistance in the flow of current also generates additional heating of parts and components. Whether vehicles use motors, batteries, fuel-cells, fuel-cells, generators or other means to propel, control, steer or monitor vehicle travel, these components generate, wear, vibrations, and excess heat that must be managed and dissipated from the system to prevent overheating and maintain proper operating temperatures and conditions. Actively monitoring systems by processing performance data and anticipating issues and vulnerabilities in systems, instead of merely alerting or notifying users of malfunctions or failures, not only complies with more rigorous safety standards, but also improves the overall efficiency of the system and the ability to adjust to a range of different dynamic conditions. This reduces costs associated with failures and can improve maintenance outcomes, but requires a more sophisticated system to implement sensor analysis to achieve and monitor the required operating conditions and parameters. Moreover, the amount of travel that would be economical for “air-taxi” or “air-cab” services using clean fuel, fuel-cell, and multirotor vehicles would be greater if the maintenance cost per vehicle could be reduced while simultaneously enhancing operational safety.

### SUMMARY

There is a need for an improved lightweight, highly efficient, fault-tolerant fuel-cell health assessment system, method, and apparatus to augment common vehicle diagnostics and notifications, especially in conjunction with power generation subsystems for a full-scale, clean fuel, electric-powered VTOL aircraft that leverages advantageous characteristics of turbochargers or superchargers and heat exchangers in its design to improve efficiency and effectiveness in monitoring and managing generation and distribution of electrical power (voltage and current) to dynamically meet needs of an aircraft (including Advanced Air Mobility aircraft) while using available resources instead of consuming or requiring additional resources to function, and to maintain one or more motors at preferred operating conditions (e.g. temperatures) for efficient vehicle performance. Further, there is a need to simultaneously dissipate waste heat from power generating subsystems and prevent power and electrical systems from overheating, failing, or malfunctioning, anticipating negative conditions before they arise in order to efficiently convert stored liquid hydrogen fuel to gaseous hydrogen fuel for supplying to fuel-cells and other power generation components, while limiting the number, mass, and size of systems used within an aircraft due to restrictions on the volume and mass of the vehicle required by flight parameters that must be adhered to in order to successfully maintain aircraft flight. The present invention is directed toward further solutions to address these needs, in addition to having other desirable characteristics. Specifically, the present invention relates to a system, method, and apparatus to predict fuel-cell issues and other component health issues before they become problems and therefore reduce fuel-cell aircraft maintenance cost significantly, while enhancing flight safety and reducing the manufacturer's warranty cost. Health assessment is vital to managing generation and distribution of electrical power using fuel-cell modules in a full-scale vertical takeoff and landing manned or unmanned aircraft, including Advanced Air Mobility (AAM) aircraft, having a lightweight airframe fuselage or multirotor airframe fuselage containing a system to generate electricity from fuels such as gaseous hydrogen, liquid hydrogen, or other common fuels (including compressed, liquid or gaseous fuels); an electric lift and propulsion system mounted to a lightweight multirotor airframe fuselage or other frame structure; counter-rotating pairs of AC or DC brushless electric motors each driving a propeller or rotor; an integrated avionics system for navigation; a redundant autopilot system to manage motors, maintain vehicle stability, maintain flight vectors and parameters, control power and fuel supply and distribution, operate mechanisms and control thermodynamic operating conditions or other vehicle performance as understood by one of ordinary skill in the art; a tablet-computer-based mission planning and vehicle control system to provide the operator with the ability to pre-plan a route and have the system fly to the destination via autopilot or to directly control thrust, pitch, roll and yaw through movement of the tablet computer or a set of operator joysticks; and ADSB or ADSB-like capability (including Remote ID) to provide traffic and situational awareness, weather display and warnings. Remote ID, as utilized herein, refers to the ability of an unmanned aircraft system (UAS) in flight to provide identification information that can be received by other parties consistent with rules and protocols promulgated by the Federal Aviation Administration (FAA). The vehicle has no tail rotor, and lift is provided by sets of electric motors, that in example embodiments comprise one or more pairs of small electric motors driving directly-connected pairs of counter-rotating propellers or rotors, or planetary or other gearbox-reduced pairs of counter-rotating propellers, also referred to as rotors. The use of counter-rotating propellers or rotors on each pair of motors cancels out the torque that would otherwise be generated by the rotational inertia. Control system and computer monitoring, including automatic computer monitoring by programmed single or redundant digital autopilot control units (autopilot computers), or motor management computers, controls each motor-controller and motor to produce pitch, bank, yaw and elevation, while simultaneously using on-board inertial sensors to maintain vehicle stability and restrict the flight regime that the pilot or route planning software can command, to protect the vehicle from inadvertent steep bank or pitch, or other potentially harmful acts that might lead to loss of control, while also simultaneously controlling cooling system and heating system parameters, valves and pumps while measuring, calculating, and adjusting temperature and heat transfer of aircraft components and zones, to protect motors, fuel-cells, and other critical components from exceeding operating parameters and to provide a safe, comfortable environment for occupants during flight. Sensed parameter values about vehicle state are used to detect when recommended vehicle operating parameters are about to be exceeded. By using the feedback from vehicle state measurements to inform motor control commands, and by voting among redundant autopilot computers, the methods and systems contribute to the operational simplicity, stability, reliability, The system, method and apparatus measure performance data produced by the generation and distribution of electrical power from fuels such as hydrogen using fuel-cell modules in implementations including a full-scale, clean-fueled, electric vehicle, particularly a full-scale multirotor vertical takeoff and landing manned or unmanned aircraft having a multirotor airframe fuselage, also referred to herein as a multirotor aircraft, This invention addresses part of the core design of a Personal Air Vehicle (PAV) or an Air Mobility Vehicle (AMV) or Advanced Air Mobility (AAM) aircraft, as one part of the On-Demand, Widely Distributed Point-to-Any Point 21st Century Air Mobility system. For clarity, any reference to a multirotor aircraft herein, includes any or all of the above noted vehicles, including but not limited to AAM aircraft. Operation of the vehicle is simple and attractive to many operators when operating under visual flight rules (VFR) in Class E or Class G airspace as identified by the Federal Aviation Administration, thus in most commuter situations not requiring any radio interactions with air traffic control towers. In other cases, the vehicle may be operated in other airspace classes, in VFR and IFR (Instrument Flight Rules) and Part 135 (aircraft for hire) operations, in the US or the equivalent regulations of other countries including, but not limited to, those with whom the US maintains a bilateral agreement governing aircraft certifications and operations. each incorporated by reference herein.

In accordance with this approach, the outputs of fuel-cell-condition sensors and environmental sensors or avionics sensors are recorded periodically, preferably many times per minute, and the results are analyzed to examine fuel-cell and motor performance trends and predict the need for fuel-cell maintenance. The result can be used to significantly reduce maintenance costs, because such monitoring makes it safe to lengthen the average time between expensive fuel-cell overhauls; overhauls can be pre-scheduled for longer intervals, with additional overhauls performed in the interim only when the results of sensor monitoring indicate the need for maintenance action.

The analysis can be performed in a number of ways. In one example embodiment, the current value of a given operating parameter such as hydrogen and oxygen pressure or fuel-cell coolant temperature, or individual cell voltage, or total voltage and current produced under a known operating point, or a particular fuel-cell temperature, or one or more motor currents at a particular RPM and torque can be compared with the values that were recorded for that parameter in previous instances of similar operating conditions; too great a difference tends to suggest that something in the fuel-cell may need attention. Another approach, which would typically be employed in parallel, would be to compare parameter values to predetermined nominal ranges. Yet another approach would be to detect values that, although not outside their nominal ranges, exhibit trends over time that if followed will soon result in out-of-bound readings. And sensed values can also be used to detect when the pilot is nearing or exceeding the recommended fuel-cell operating conditions, or when the motors are being driven close to or beyond the permissible RPM and torque, which may indicate excessive wear or bearing issues or other factors affecting motor or fuel-cell reliability. Such analyses' results contribute to maintenance-cost reduction in at least a couple of ways. Between flights, maintenance personnel can consult the analysis results to determine when an overhaul is likely to be needed and, possibly, its extent. The results can also be used during or at the conclusion of each flight to alert the pilot to the occurrence of conditions that, typically without yet having impaired safety, indicate that some maintenance action should be taken. Both approaches contribute to the level of safety that can be achieved despite significant maintenance-budget reduction.

In accordance with example embodiments of the present invention, a method for monitoring performance of a fuel-cell and motor system uses one or more autopilot control units or processors for computer units and obtains current fuel-cell and individual motor performance data from the fuel-cell and motor systems reported by one or more onboard sensors during flight operation and current aircraft performance data from the aircraft reported by a plurality of onboard aircraft sensors and data stores during flight operation. The method then compares the current aircraft performance data with prior aircraft performance data to identify quantitative ranges of operation where the current aircraft performance data overlaps with the prior aircraft performance data within a predetermined range of acceptable difference to identify a quantitative range of similar aircraft performance, accounting for differences in atmospheric conditions (pressure, altitude, and temperature for the flight in question). The method then matches the quantitative range of similar aircraft performance with a similar range corresponding to prior fuel-cell and/or motor performance data to identify a subset of prior fuel-cell and motor performance data. The current fuel-cell or motor performance data is compared with the subset of prior fuel-cell or motor performance data and differences in fuel-cell and motor performance data are identified. The differences in fuel-cell performance data and motor performance data are transformed to one or more health indicators using a processor and one or more algorithms. The health indicators are output to a user interface in the form of the health assessment and warnings about any exceedances or warnings that may have been logged during the flight.

In accordance with aspects of the present invention, the health assessment includes one or more of a graph, message, text warning, and indicator for a pilot, owner of maintenance personnel. In some aspects, the health assessment can be used for trend analysis or in a predictive manner

In accordance with aspects of the present invention, the display device can comprise a primary flight display or avionics display with an arrangement of standard avionics used to monitor and display one or more of operating conditions, control panels, gauges instrument output and sensor output for a clean fuel aircraft. Alternatively, the display mechanism may shield the pilot or vehicle operator from non-flight-critical warnings, and instead report them via datalink either while airborne or upon returning to the ground. Obtaining the current performance data of the fuel-cell and motor system can comprise obtaining at least one instrument output or sensor output taken from a listing of outputs measuring one or more of hydrogen temperature, oxygen temperature, fuel temperature, fuel tank temperature, fuel-cell system output voltage and current, hydrogen fuel flow, humidity, motor temperature, motor controller temperatures, stack temperatures, coolant temperature, radiator temperature, heat exchanger temperature, battery temperature (if present), hydrogen pressure, oxygen or air pressure, propeller/rotor speed (RPM), or outputs of fuel-cell-internal-condition sensors. Obtaining current aircraft performance data can comprise obtaining at least one instrument output or sensor output taken from a listing of outputs measuring one or more of true airspeed, indicated airspeed, pressure altitude, density altitude, outside air temperature, vertical speed, motor rpm(s) at hover, motor rpm(s) at known forward airspeed, motor temperature(s), and motor controller temperature(s). Obtaining the current fuel-cell and motor performance data can further comprise periodically obtaining and recording at least one instrument output or sensor output at environmental conditions gathered from the current aircraft performance wherein the at least one instrument output or sensor output comprises an output from one or more of an altimeter, an airspeed indicator, a vertical speed indicator, a magnetic compass, an attitude Indicator, an artificial horizon, a heading indicator, a directional gyro, a slip or skid horizontal situation indicator (HSI), a turn indicator, a turn-and-slip indicator, a turn coordinator, an indicator of rotation about a longitudinal axis, an inclinometer, an attitude director indicator (ADI) with computer-driven steering bars, a navigation signal indicator, a glide slope indicator, a very-high frequency omnidirectional range (VOR) course deviation indicator (CDI)/localizer, a GPS, an omnibearing selector (OBS), a TO/FROM indicator, a nondirectional radio beacon (NDB) instrument, flags instruments, an automatic direction finder (ADF) indicator instrument, a radio magnetic indicator (RMI), a gyrocompass, instruments representing aircraft heading, inertial measurements indicating pitch, roll, yaw, pitch-rate, roll-rate, yaw-rate, and accelerations in all 3 coordinates, a glass cockpit instruments primary flight display (PFD), a temperature sensing device, a thermal safety sensor, a pressure gauge, a level sensor, a vacuum gauge, operating conditions sensors in a clean fuel aircraft, or combinations thereof. The above list is presented as an example, and does not necessarily embody every type of sensor intended to show aircraft data.

In accordance with aspects of the present invention, obtaining current fuel-cell and motor performance data further includes determining, from fuel-cell and motor performance data, if the fuel-cell and motor system is operating within a predetermined parameter set or exceeds predefined fuel-cell and motor system operating conditions by deriving performance data values from the performance data, accessing the predetermined parameter set previously stored, and analyzing whether comparison to corresponding predetermined parameter set values indicates deviation larger than a threshold stored in the predetermined parameter set. Comparing the current aircraft performance data with prior aircraft data can include determining if trend records for a predetermined number of previous uses are stored. Comparing the current aircraft performance data with prior aircraft performance data can include obtaining averages for values stored in the trend records for previous uses and comparing values of a current trend record to corresponding averages from the trend records for the predetermined number of previous uses. Obtaining averages can comprise obtaining averages for chronological groupings of trend records for previous uses.

In accordance with aspects of the present invention, the comparing the current fuel-cell and motor performance data with a subset of prior fuel-cell and motor performance data can comprise obtaining a predicted value for at least one instrument output or sensor output; storing a difference between the predicted value and an actual value of the at least one instrument output or sensor output to a current trend record; and storing other instrument outputs or sensor outputs to a current trend record. The comparing the current fuel-cell and motor performance data with a subset of prior fuel-cell and motor performance data can also include obtaining predicted values for the fuel-cell and motor system performance data at environmental conditions; and storing differences between the predicted values and actual values of the fuel-cell and motor system performance data to a current trend record. The outputting health indicators can include displaying values of a current trend record, displaying corresponding averages, and displaying tolerances or thresholds associated with respective values of the current trend record. The displaying can comprise displaying values associated with instrument outputs or sensor outputs using a Controller Area Network (CAN) bus, taken from a listing of outputs including motor speed, fluid pressure, hydrogen fuel flow, air speed, altitude, cell temperature, cell pressure, maximum stack temperature, minimum stack temperature, maximum exhaust temperature, temperature of the first cell in the stack up through and including the temperature of the last cell in the stack, wherein one or more fuel-cell cells and one or more motor controllers are each configured to self-measure and report temperature and other parameters.

In accordance with aspects of the present invention, obtaining the current fuel-cell and motor performance data can comprise providing an indication to an operator when a value of at least one of instrument output or sensor output differs from a predicted value by more than a predetermined tolerance or threshold. The method can further comprise obtaining the predicted value from a database or a lookup table that is computer-based, and performing, using the one or more autopilot control units or processors, interpolation calculations within the database or the lookup table. Performing, using the one or more autopilot control units or processors, interpolation calculations within the lookup table, can use machine learning or regression analysis to perform interpolation. Outputting can further comprise displaying a historical record corresponding to a periodically obtained at least one instrument output or sensor output.

In accordance with aspects of the present invention, the fuel-cell system can be a hydrogen fuel-cell system. The fuel-cell system can be an aircraft fuel-cell system.

In accordance with aspects of the present invention, the method can further comprise controlling the fuel-cell and motor system to operate within a predetermined parameter set. Controlling the fuel-cell and motor system to operate within the predetermined parameter set can comprise one or more autopilot control units operating control algorithms generating commands to each of the plurality of fuel-cells and each of the plurality of motor controllers, and fuel supply subsystem and managing and maintaining multirotor aircraft stability for the clean fuel aircraft and monitoring feedback. Controlling the fuel-cell and motor system to operate within the predetermined parameter set can comprise maintaining a certain altitude to allow the fuel-cell and motor system to stabilize, setting the fuel-cell and motor system at a recommended percent cruise voltage and current, setting corresponding oxygen fuel supply and hydrogen fuel supply to each of the plurality of fuel-cells based on the performance data for each of the plurality of fuel-cells, setting a recommended best performance voltage and current, and corresponding oxygen supply and hydrogen supply to each of the plurality of fuel-cells, and setting a recommended best economy voltage and current, and corresponding oxygen supply and hydrogen supply to each of the plurality of fuel-cells. Controlling the fuel-cell and motor system to operate within the predetermined parameter set can also comprise measuring, using one or more sensors, operating conditions in a fixed wing or multirotor aircraft, and then performing comparing, computing, selecting and executing steps using the performance data for one or more fuel-cell and motor modules to iteratively manage electric voltage and current or torque production and supply by the one or more fuel-cell and motor modules and operating conditions in the multirotor aircraft. The at least one instrument or sensor can report performance data using a controller area network (CAN) bus to inform the autopilot control units or processors for computer units as to a particular valve, pump, vent, transducer or combination thereof to enable to increase or decrease fuel supply or cooling using fluids, wherein the one or more autopilot control units comprise at least two redundant autopilot control units that command the plurality of motor controllers, the fuel supply subsystem, the one or more fuel-cell modules, and fluid control units with commands operating valves, pumps, vents and transducers altering flows of fuel, air and coolant to different locations. The at least two redundant autopilot control units can communicate the voting process over a redundant network. The method can repeat in an iterative process at set intervals, establishing stable cruise conditions, then recording performance data at the stable cruise conditions and plotting trend lines to display key performance indicators results.

In accordance with aspects of the present invention, the recommended best performance voltage and current, and the recommended best economy voltage and current, can be set using the current fuel-cell and motor performance data, the prior fuel-cell and motor performance data, the predetermined parameter set, and indicators of how efficient the plurality of fuel-cells and motors are operating during a current flight compared against prior flights at designated matching performance parameters and operating conditions, comprising one or more of payload on-board, forward cruise speed, vertical speed, air temperature, air density or pressure, altitude, fuel-cell module current, fuel-cell module voltage, total current, total voltage, motor torque, total power, coolant temperature, hydrogen flow rate and fuel pressure.

In accordance with aspects of the present invention, obtaining the current aircraft performance data can comprise accessing data from a third set of a plurality of onboard sensors of the aircraft that are linked in a network and gathering sensor outputs from the network that are then aggregated and processed by an onboard processor or a remote processor to generate a model of the aircraft represented using a primary flight display or avionics display graphical user interface that maintains proportional relationships between graphical representations of sensor elements and other aircraft elements that accurately reflect actual distances and configurations of onboard sensors and aircraft elements.

In accordance with example embodiments of the present invention, a system for monitoring performance of a fuel-cell and motor system includes one or more onboard sensors reporting fuel-cell and motor performance during flight operation; a plurality of onboard aircraft sensors and data stores reporting current aircraft performance data during flight operation; one or more autopilot control units or processors for computer units; and a display. The one or more autopilot control units or processors for computer units perform the steps of: comparing the current aircraft performance data with prior aircraft performance data to identify ranges of operation where the current aircraft performance data overlaps with the prior aircraft performance data within a predetermined range of acceptable difference to identify a time segment of similar aircraft performance; matching the time segment of similar aircraft performance with a similar range corresponding to prior fuel-cell and motor performance data to identify a subset of prior fuel-cell and motor performance data; comparing the current fuel-cell and motor performance data with the subset of prior fuel-cell and motor performance data and identifying differences in fuel-cell and motor performance data; transforming the differences in fuel-cell and motor performance data to one or more health indicators using a processor and one or more algorithms. The display outputs the health indicators to a user interface in the form of the health assessment.

In accordance with aspects of the present invention, the fuel-cell and motor system can comprise at least one fuel-cell module comprising one or more hydrogen fuel-cells in at least one stack, configured to supply electrical voltage and current to a one or more motors and propeller or rotor assembly controlled by one or more motor controllers, and in fluid communication with one or more heat exchangers and one or more turbochargers or superchargers. Each hydrogen fuel-cell of the one or more hydrogen fuel-cells can comprise a hydrogen flowfield plate, disposed in each hydrogen fuel-cell, and comprising a first channel array configured to divert gaseous hydrogen (GH₂) inside each hydrogen fuel-cell through an anode backing layer connected thereto and comprising an anode gas diffusion layer (AGDL) connected to an anode side catalyst layer that is further connected to an anode side of a proton exchange membrane (PEM), the anode side catalyst layer configured to contact the GH₂ and divide the GH₂ into protons and electrons. Each hydrogen fuel-cell can comprise an oxygen flowfield plate, disposed in each hydrogen fuel-cell, and comprising a second channel array configured to divert compressed air inside each hydrogen fuel-cell through a cathode backing layer connected thereto and comprising a cathode gas diffusion layer (CGDL) connected to a cathode side catalyst layer that is further connected to a cathode side of the PEM, wherein the PEM comprises a polymer and is configured to allow protons to permeate from the anode side to the cathode side but restricts the electrons. Each hydrogen fuel-cell can comprise an electrical circuit configured to collect electrons from the anode side catalyst layer from each hydrogen fuel-cell of the one or more hydrogen fuel-cells and supply voltage and current to the one or more motor controllers and aircraft components, wherein electrons returning from the electrical circuit combine with oxygen in the compressed air to form oxygen ions, then the protons combine with oxygen ions to form H₂O molecules; wherein the one or more motor controllers are commanded by the one or more autopilot control units or processors of computer units, comprising a computer processor configured to compute algorithms based on measured operating conditions, and configured to select and control an amount and distribution of electrical voltage and torque or current for each of the one or more motor and propeller or rotor assembly. Each hydrogen fuel-cell of the one or more hydrogen fuel-cells can comprise: an outflow end of the oxygen flowfield plate configured to use the second channel array to remove the H₂O and the compressed air from each hydrogen fuel-cell; and an outflow end of the hydrogen flowfield plate configured to use the first channel array to remove exhaust gas from each hydrogen fuel-cell. The at least one fuel-cell module can further comprise a module housing, a fuel delivery assembly, air filters, blowers, airflow meters, a recirculation pump, a coolant pump, fuel-cell controls, sensors, an end plate, coolant conduits, connections, a hydrogen inlet, a coolant inlet, an oxygen inlet, a hydrogen outlet, air and/or oxygen outlets, a coolant outlet, and coolant conduits connected to and in fluid communication with the at least one fuel-cell module and transporting coolant.

In accordance with aspects of the present invention, the fuel-cell and motor system can further comprise: a fuel supply subsystem comprising a fuel tank in fluid communication with the at least one fuel-cell module, fuel lines, fuel pumps, refueling connections for charging or fuel connectors, one or more vents, one or more valves, one or more pressure regulators, and unions, each in fluid communication with the fuel tank that is configured to store and transport a fuel comprising gaseous hydrogen (GH₂) or liquid hydrogen (LH₂); a thermal energy interface subsystem comprising a heat exchanger in fluid communication with the fuel tank and the at least one fuel-cell module including each hydrogen fuel-cell of the plurality of hydrogen fuel-cells, a plurality of fluid conduits, and at least one radiator in fluid communication with the at least one fuel-cell module, configured to store and transport a coolant; a power distribution monitoring and control subsystem for monitoring and controlling distribution of supplied electrical voltage and current from the plurality of hydrogen fuel-cells to the plurality of motor controllers that are high-voltage, high-current liquid-cooled or air-cooled motor controllers. The power distribution monitoring and control subsystem can comprise: one or more sensors configured to measure operating conditions and output performance data or environmental data, wherein one or more sensors monitor temperatures and concentrations of gases in the fuel supply subsystem, and also comprise one or more pressure gauges, one or more level sensors, one or more vacuum gauges, one or more temperature sensors; wherein the one or more autopilot control units or processors of computer units comprise: a computer processor and input/output interfaces comprising at least one of interface selected from serial RS232, controller area network (CAN), Ethernet, analog voltage inputs, analog voltage outputs, pulse-width-modulated outputs for motor control, an embedded or stand-alone air data computer, an embedded or stand-alone inertial measurement device, and one or more cross-communication channels or networks, a mission planning computer comprising software, with wired or wireless (RF) connections to the one or more autopilot control units; a wirelessly connected or wire-connected automatic dependent surveillance-broadcast (ADSB) unit providing the software with collision avoidance, traffic, emergency detection and weather information to and from the clean fuel aircraft; and the one or more autopilot control units or processors configured to compute, select and control, based on one or more algorithms, an amount and distribution of voltage and current from the plurality of hydrogen fuel-cells of the power generation subsystem to each of the plurality of motor and propeller or rotor assemblies each comprising a plurality of pairs of propeller or rotor blades, and each being electrically connected to and controlled by the plurality of motor controllers, using one or more air-driven turbochargers or superchargers supplying air to the at least one fuel-cell module, and dissipate waste heat using the thermal energy interface subsystem, wherein H₂O molecules are removed using one or more exhaust ports or a vent.

In accordance with aspects of the present invention, the display device can comprise a primary flight display or avionics display with an arrangement of standard avionics used to monitor and display one or more of operating conditions, control panels, gauges and sensor output for a clean fuel aircraft.

In accordance with aspects of the present invention, obtaining current fuel system performance data s can comprise obtaining at least one instrument output or sensor output taken from a listing of outputs measuring one or more of hydrogen temperature, oxygen temperature, fuel temperature, fuel tank temperature, fuel-cell system speed, hydrogen fuel flow, humidity, motor temperature, motor controller temperatures, stack temperatures, coolant temperature, radiator temperature, heat exchanger temperature, battery temperature, exhaust fluid temperature, concentrations of gases in the fuel supply subsystem, fluid pressure, propeller speed (RPM), or outputs of fuel-cell-condition sensors. Obtaining the current aircraft performance data can comprise obtaining at least one instrument output or sensor output taken from a listing of outputs measuring one or more of true airspeed, indicated airspeed, pressure altitude, density altitude, outside air temperature, and vertical speed.

In accordance with aspects of the present invention, a third set of a plurality of onboard sensors of the aircraft can be linked in a network and sensor outputs from the network are aggregated and processed by an onboard processor or a remote processor to generate a model of the aircraft represented using a primary flight display or avionics display graphical user interface that maintains proportional relationships between graphical representations of sensor elements and other aircraft elements that accurately reflect actual distances and configurations of onboard sensors and aircraft elements. The model can provide an explorable, interactive three-dimensional digital representation of the aircraft with graphical representations and/or audiovisual representations that augment the model to convey sensor output or output measurements comprising one or more of alpha-numeric symbols, illumination, color changes, flags, highlights or combinations thereof indicating sensor locations to call attention to various occurrences or data related to a set of onboard aircraft sensors or a specific region of the aircraft. The model may be programed to change display parameters and output when various aircraft operating states are altered, based on onboard sensor feedback patterns that emerge across sensor subsets or regions on the model that correspond to actual sensor readings experienced by the aircraft that are mapped onto a model display using a remote or onboard processor to readily identify potential hazards in the operation of aircraft that are conglomerated to be more readily apparent than referring to each set of sensor data individually. The model can enable representation of data for sensor groupings over time in addition to current sensor output, including display of prior aircraft operating states and changes in data or trend data for comparison to identify regions of the aircraft that are behaving dynamically or diverging from steady state or usual operating parameters.

### BRIEF DESCRIPTION OF THE DRAWINGS

The invention description below refers to the accompanying drawings, of which:

FIG. 1 depicts an example block diagram depicting an apparatus for practicing the present invention;

FIG. 2 depicts a flow chart of an example routine that illustrates one way in which the present invention can be implemented;

FIG. 3 depicts a flow chart that depicts one the workflows of FIG. 2 in more detail;

FIGS. 4A-4D depicts an example system block diagram for practicing the present invention, including logic controlling the integrated system and related components;

FIG. 5 depicts an example of control panels, gauges and sensor output for the multirotor aircraft;

FIG. 6 depicts an example of display output for health assessment and performance data derived from sensor output for the multirotor aircraft;

FIG. 7 depicts an example of the type of display that could be used to present health data generated by the system;

FIG. 8 depicts an example of a trend monitoring data log;

FIG. 9 depicts an example more detailed block diagram, focused on an example fault-tolerant, triple-redundant voting control and communications means;

FIG. 10 depicts electrical and systems connectivity of various fuel-cell, fuel supply, power generation, and motor control components of a system of the invention;

FIG. 11 depicts an example production system block diagram for practicing the present invention, including components and subsystems connected by CAN bus;

FIG. 12 depicts example configurations of fuel-cell modules within the multirotor aircraft;

FIG. 13 depicts example subcomponents of fuel-cells in at least one fuel-cell module within the multirotor aircraft;

FIG. 14 depicts example internal subcomponents of fuel-cells within the multirotor aircraft;

FIG. 15 depicts profile diagrams of the multirotor aircraft demonstrating example positions of fuel-cell assessment and monitoring system components and power generation subsystems within the multirotor aircraft;

FIG. 16 depicts example diagrams of the configuration of power generation subsystem heat transfer and exchange source components within the multirotor aircraft that depicts two views demonstrating the position and compartments housing the fuel supply and power generation subsystems depicting coolant fluid conduits;

FIG. 17 depicts side and top views of a multirotor aircraft with six rotors cantilevered from the frame of the multirotor aircraft in accordance with an embodiment of the present invention, indicating the location and compartments housing the fuel supply and power generation subsystems; electrical and systems connectivity of various fuel supply, power generation, and motor control components of a system of the invention;

FIG. 18 depicts example subcomponents of fuel tanks and fuel supply subsystem within the multirotor aircraft;

FIG. 19 depicts an example diagram of the fuel tank, fuel-cell, radiator, heat exchanger and air conditioning components and interrelated conduits for heat transfer among components; and

FIG. 20 depicts a flow chart that illustrates the present invention in accordance with one example embodiment.

### DETAILED DESCRIPTION

To provide an overall understanding, certain illustrative embodiments will now be described; however, it will be understood by one of skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods.

An illustrative embodiment of the present invention relates to an apparatus, system and method producing health assessments of a fuel-cell and motor system powering an aircraft, to predict, anticipate or detect problems in components or improper operating conditions prior to actual physical failures, to improve robustness and reliability while maintaining suitable operating characteristics. The apparatus, method and system can be integrated into a full-scale clean fuel electric-powered multirotor aircraft, including AAM aircraft and all equivalents as discussed previously herein. Examples of such vehicles are set forth in U.S. Pat. Nos. 9,764,822 and 9,242,728, incorporated by reference herein. The one or more fuel-cell modules of the integrated system comprise a plurality of fuel-cells individually functioning in parallel or series but working together to process gaseous oxygen from ambient air compressed by turbochargers or superchargers (or blowers or supplemental stored oxygen supply O₂ in place of those components) and gaseous hydrogen extracted from liquid hydrogen by pressure altering expansion components or temperature altering heat exchangers (or stored in gaseous form). Gaseous hydrogen is passed through fuel-cell layers including a catalyst and a proton exchange membrane (PEM) of a membrane electrolyte assembly wherein protons, disassociated from electrons using an oxidation reaction, are passed through the membrane while electrons are prevented from traversing the membrane. The one or more fuel-cell modules of the integrated system use an electrical circuit configured to collect electrons from the plurality of hydrogen fuel-cells to supply voltage and current to motor controllers commanded by autopilot control units configured to select and control an amount and distribution of electrical voltage and torque or current for each of the plurality of motor and propeller or rotor assemblies. Electrons returning from the electrical circuit to a different region within the fuel-cells containing a catalyst combine with oxygen within or separated from the compressed air to form oxygen ions. Then, through reactions involving the catalyst, the protons previously separated from electrons combine with oxygen ions to form H₂O molecules and heat. The integrated system comprises at least a power generation subsystem. Lift and propulsion are provided by sets (that may comprise pairs) electric motors each driving geared or directly-connected counter-rotating propellers, also referred to as rotors. The use of counter-rotating propellers or rotors on each pair of motors cancels out the torque that would otherwise be generated by the rotational inertia. The integrated system also comprises a fuel supply subsystem comprising a fuel tank in fluid communication with one or more fuel-cell modules and configured to store and transport a fuel such as liquid hydrogen, gaseous hydrogen, or a similar fluid. One or more vents, one or more outlets, and one or more exhaust ports; one or more temperature sensing devices or thermal energy sensing devices, configured to measure thermodynamic operating conditions; and an autopilot control unit comprising a computer processor configured to compute a temperature adjustment protocol comprising one or more priorities for energy transfer using one or more thermal references and an algorithm based on a comparison result of measured operating conditions including thermodynamic operating conditions, and configured to select and control, based on the temperature adjustment protocol, an amount and distribution of thermal energy transfer from one or more sources to one or more thermal energy destinations. Fuel-cell modules, motors, motor controllers, batteries, circuit boards, and other electronics require excess or waste heat to be removed or dissipated. The integrated system comprises one or more radiators or heat exchangers in fluid communication with the one or more fuel-cell modules, configured to store and transport a coolant with a plurality of fluid conduits. When power is provided by one or more fuel-cell modules for generating electrical voltage and current, electronics monitor and control electrical generation and excess heat or thermal energy production, and motor controllers then control the commanded voltage and current to each motor and to measure its performance. Using control systems including automatic computer monitoring by programmed digital autopilot control units (autopilot computers), or motor management computers, the integrated system controls each motor-controller and motor to produce pitch, bank, yaw and elevation, while also simultaneously controlling cooling and heating parameters and thermodynamic operating conditions, valves and pumps while measuring, calculating, and adjusting fuel supply, current, voltage, temperature and heat transfer of aircraft components, to protect motors, fuel-cells, and other critical components from exceeding operating parameters. The fuel-cells of the power generation subsystem comprise embedded measurement components (e.g. sensors) and capabilities. In an example embodiment, the fuel-cell can be queried in real time over the CAN bus, and then analyze and determine what the health status of each individual cell within the stack is at that interval. The status can be output to available displays. Alternative embodiments can implement reporting techniques alternative to use of CAN data. The equipment, components, and steps or techniques satisfy regulations including relevant portions of FAA Part 135 requirements requiring passenger carrying air vehicles (e.g. “air taxi” operators) for hire to possess a trend monitoring capability to detect potential power supply problems before they occur. Here the power generation subsystem uses one or more fuel-cells that are monitored in fuel-cell-powered eVTOLs.

Using the integrated system, periodic measurements are taken and data is aggregated and stored, including for later use on the ground, similar to the manner in which flight data recorders operate. Additionally, data can be transmitted in real-time to the ground for immediate analysis by automated systems. In one embodiment, an on-board encrypted datalink digitally transmits fuel-cell and motor health/status data to the ground station at various selectable time intervals. In an example embodiment, data is transmitted once a second, or once every 10 seconds or at longer or shorter intervals, as understood by a person having ordinary skill in the art. Transmitted data received on the ground is analyzed using algorithms that can be run on the data to compare fuel-cell and motor performance against a historical record of the same vehicle over a time period (e.g. the life of the vehicle, or the past 10-20 flights) to inspect and find any changes or degradation. Each fuel-cell component (e.g. individual cells) can also be compared to detect weak or weakening cells. The overall set of fuel-cells (e.g. 3 fuel-cells) or the power generation subsystem as a whole can be assessed for performance against historical data, when e.g. running at a known load point. This may include establishing stable cruise conditions, recording various temperatures (air temperature, coolant temperature, component temperatures, etc.) altitude, payload on-board, forward cruise speed, air density, current, voltage, total power, hydrogen flow rate, fluid pressures, and other measurements that indicate how efficiently the fuel-cells and motors are operating on the particular flight vs. prior flights at the same or similar conditions including e.g. altitude or temperature.

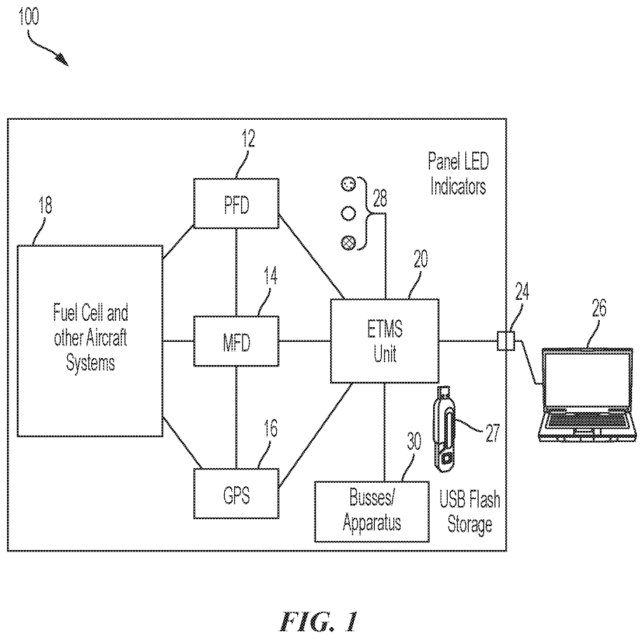

FIGS. 1-20, wherein like parts are designated by like reference numerals throughout, illustrate an example embodiment or embodiments of a lightweight, high efficiency, fuel-cell health assessment and monitoring apparatus, method and system, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

FIG. 1 depicts a block diagram of one type of apparatus and system that may be employed for practicing the present invention. Conventionally, a small, fuel-cell aircraft will include on-board equipment such as a primary flight display 12, a multi-function display (MFD) 14, and a global-positioning system (GPS) 16, all of which monitor the operation of the fuel-cell module 18 and other aircraft systems and provide outputs that represent various aspects of those systems' operation and the aircraft's state data, such as altitude, air speed and outside air temperature and/or other environmental data. Not all aircraft employ the same combination of instrumentation. Whatever the combination of instruments the aircraft possesses, some set of instrument outputs will be collected by a fuel-cell-trend-monitoring-system unit 20, which records the collected data in memory, such as the illustrative removable flash memory 22 of FIG. 1 and performs analyses on the collected data as described herein. Monitoring unit 20 will typically be embodied in a microprocessor-based circuit and include the various interface circuitry required to communicate with the aircraft's data busses and/or exterior apparatus 30. In addition, or instead, monitoring unit 20 may be configured for manual recording of some instrument outputs.

In an example illustrated embodiment, the analyses described herein may be performed exclusively by the on-board monitoring unit 20, with separate, ground-based equipment performing little if any of the analyses. Although that approach is preferred, various aspects of the invention can be practiced with a different division of labor; some or all of the analyses—indeed even some or all of the recording—can in principle be performed outside the aircraft, in ground-based equipment, by using a data-link between the aircraft and the ground-based equipment. Although it is preferable to perform the analyses on the aircraft, it will be apparent to one of ordinary skill in the art in many applications to use separate, typically ground-based apparatus to display the results of the various analyses and/or to compare the results from one aircraft with one or more other aircraft or to averages of a number of aircraft, as in fleet averages. To indicate this fact, FIG. 1 includes a ground-access port 24, which in practice could be, for instance, an Ethernet connector or some type of wireless or digital mobile broadband network interface. Preferably, the monitoring unit 20 will provide the data in a web-server fashion: a processor/display 26, such as, but not limited to a conventional laptop, desktop computer, or other personal computer configured to run a conventional web browser can communicate with the unit, which can respond by sending the requested information in a web-page format. Obviously, though, other data-transmission formats, processors and/or displays can be used in addition or instead.

Some embodiments may additionally or instead make the detailed information display available in the aircraft itself. The reason why the illustrated embodiment does not is that in many of the small, single-pilot aircraft to which the present invention's teachings will be of most benefit it is best to keep at a minimum the number of items to which flight personnel need to direct their attention. But some results of the analyses can be helpful to flight personnel and may be displayed or provided via a data channel for display as text and/or graphics on existing avionics' displays. As an example, the system 20 can monitor performance against the approved limits established in the manufacturer's FAA-approved Aircraft Flight Manual (AFM) for the aircraft, sometimes also be known as the Pilot's Operating Handbook (POH), and may alert the pilot to exceedances. Accordingly, some embodiments may compromise between that benefit and the goal of minimizing pilot distraction by including a rudimentary display to advise the pilot when he has entered an exceedance condition.

For the illustrative embodiment of FIG. 1, such a display may consist of, say, less than half a dozen indicator lights 28, preferably in the form of light-emitting diodes (LEDs). Exemplary applications of LEDs 28 may include using a single green LED to indicate that the monitoring system has currently detected no anomalies. A flashing yellow LED could be used to indicate that the pilot is operating the aircraft's fuel-cell outside of normal limits and should adjust operating settings to values that are consistent with the AFM. A steady yellow light may indicate that one of the monitored parameters has undergone a significant change. The appropriate response for the pilot in such a situation would typically be to report that fact to the appropriate maintenance personnel. A flashing red light may be employed as an indication that, although no particular parameter has undergone an unusually drastic change or strayed outside of nominal limits, one or more have exhibited worrisome trends, so particular attention to flight logs is justified. A steady red light may indicate an exceedance condition.

Other combinations of colors and/or flashing and/or steady lights, as well as audible signals may be used to convey this or other information and/or warnings to the pilot. For example, combinations of green and yellow LEDs could be used to indicate that the pilot is operating the aircraft within or outside of certain predetermined “cruise” conditions. As will be seen below, operating the aircraft within “cruise” conditions will serve the purpose of making data comparisons more meaningful. In addition or instead of the LEDs 28, the information display may be incorporated in new and/or available aircraft cockpit displays, such as the GPS unit 16 and/or MFD 14, to which information is digitally transmitted for display to the pilot.

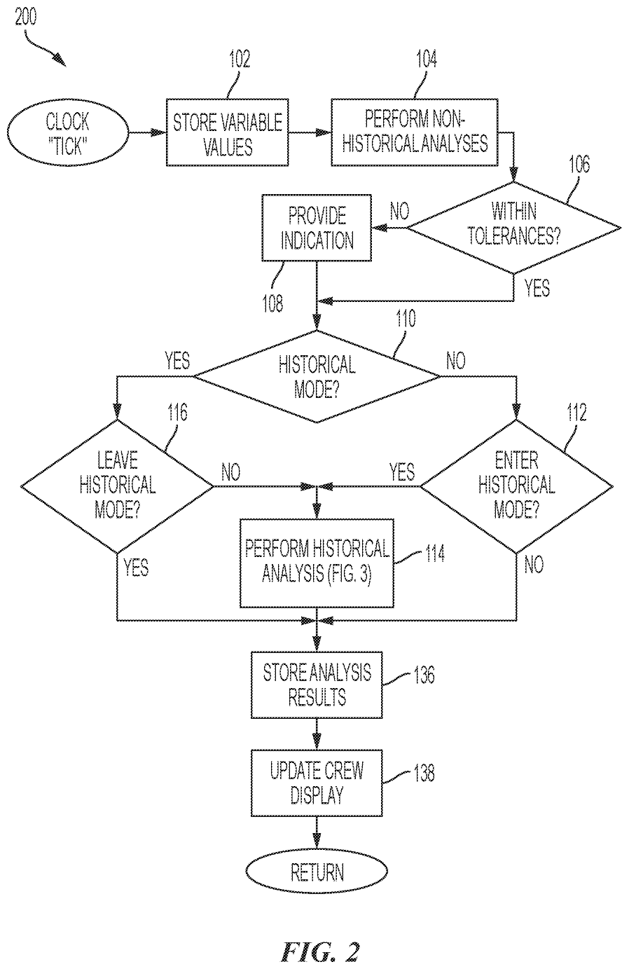

FIG. 2 depicts a flow chart of a routine that illustrates one way in which the present invention can be implemented in simplified form as a monitoring-analysis-approach that some embodiments of the invention may employ. For the sake of simplicity, it is assumed here that the system enters the routine 200 periodically, at every “tick” of a sensor-system clock. The frequency at which this occurs will be selected to be appropriate to the parameters being recorded, and in some cases the frequencies may be different for different parameters. Again, for simplicity, though, it is assumed here that the frequency is the same for all of them, and, for the sake of concreteness, assume a frequency of once every three seconds. As FIG. 2's step 102 indicates, the system 100 first records various sensor outputs (e.g. outputs from thermometers, thermocouples, heat sensors, flow meters, accelerometers, tilt sensors, etc.). In typical modern-day avionics, such data may be readily accessed through the aircraft's various data busses, and the illustrated embodiment selects among the various quantities that can be obtained in that manner. A representative group of aircraft measurements obtained in this manner may be air speed, altitude, latitude and longitude, outside-air temperature (OAT), the number of propeller or rotor revolutions per minute (RPM), H₂ fuel pressure, fuel-cell pressure, the rate of fuel flow (FF), maximum exhaust-gas temperature, stack current, stack power, stack voltage, stack type, module type, rated power, rated voltage, LB Current, LB Voltage, LB Power, LB condition, temperature setpoint, efficiency, auxiliary pressure, auxiliary/ambient temperature, recirc, pulse width modulation (PWM), CDA pwm, fan pwm, blower pwm, coolant pwm, recir. Current, recir, frequency, blower frequency, 5 vdc rail, 12 vac rail, CDR/H2 sensor, HV sensor, air flow.

With the sensor data thus taken, the system 100 performs various analyses, as at step 104, which may be used to detect anomalies or hazards to aircraft health (including or operating conditions or state). Step 104 refers to these various analyses as “non-historical”, since they depend only on current or very recent values. For many of the parameters, there are predetermined limits or thresholds with which the system 100 compares the measured values. These may be limits on the values themselves and/or limits in the amount of change since the last reading or from some average of the past few readings as set by default or by operator input. Other possible data analyses metrics include flight miles per gallon as an index of fuel-cell operating efficiency, fuel-cell Blade HorsePower (BHP) as computed from observed parameters, temperature span between minimum and maximum CHT, temperature span between EGT for first cylinder to peak and last cylinder to peak, FF span between first cylinder to peak and last cylinder to peak, and fuel-cell duty cycle histograms. Fuel-cell life is directly influenced by duty cycle as determined by time spent at higher power settings. Fuel-cells which operate for longer periods at takeoff power settings tend to see reduced life and a greater frequency of component problems.

Additionally, there are readings that, although they reflect no maintenance issues, indicate that the aircraft crew needs to take some action. To obtain maximum efficiency, for example, particular values of MAP and FF as a function of altitude and/or air speed may be known to be desired. Also, the system 100 may observe exhaust temperature as a function of fuel mixture and infer the desired temperature. At step 106, the system can determine if such measured performance parameters are within certain tolerances of expected values. The system 100 may then advise the crew to adjust performance to the expected values if it has departed from desired operating conditions, as at step 108. Such advice or adjustment indications may be provided to the crew as discussed in relation to FIG. 1, i.e., through displays, such as LEDs 28 of flight displays, and/or audible signals.

Performance parameters are typically provided in the POH for the aircraft. For example, the POH may provide lookup tables for expected operational parameters, such as FF and air speed at a specific MAP, rpm, % power, altitude and outside air temperature. In addition to the expected operational parameters found in the POH, the system can maintain a database of, and/or the non-historical analyses of step 104 can provide, projected fuel-cell and motor performance parameter values including, without limitation, CHT, EGT, CHT span, EGT span and other performance parameters discussed herein.

The system 100 also performs “historical” analyses, i.e., compares current values with the values that the same aircraft previously exhibited under matching conditions. The quality of the conclusions to be drawn from comparing a given flight's data with data from previous flights may initially seem problematic, since flight conditions vary so widely. The illustrated embodiment uses a number of expedients and/or corrections to mitigate this problem. First, as stated above in relation to LEDs 28, the system 100 prompts the crew to adopt certain predetermined, “cruise” conditions so that, for a given set of altitude and outside-air-temperature conditions, or set of parameters, variations in fuel-cell operating values will be relatively modest. As an example of adopting “cruise” conditions, the crew may: (1) maintain a certain altitude; (2) set cruise power in accordance with the applicable POH (e.g. 72%±2%); and (3) set air (O₂) and GH₂ supply to best power mixture in accordance with POH. In certain example embodiments, the mixture may be set to best economy mixture.

As another way of mitigating problems associated with comparisons using varying flight conditions is where an illustrated embodiment performs the historical analysis only when it is in a “historical” mode, which it adopts when the aircraft 1000 has been in the predetermined cruise regime for a predetermined amount of time. Additionally, the projected fuel-cell and motor performance parameter values can be used in performing the flight data comparisons. For example, the divergence in altitude between the current flight and a previous flight might be so great that direct comparison of the respective flight's operational parameters for trending may not provide reliable results. However, such divergences can be compensated for by making comparisons using the differences between the projected fuel-cell and motor performance parameter values and the actual values.

As step 110 indicates, the system determines whether it has already entered its historical-analysis mode. If not, it then determines whether the aircraft has been operating stably under cruise conditions at step 112. This can be determined by, for example, observing that the number of propeller or rotor revolutions per minute has stayed within a suitably small range for some predetermined length of time, e.g., 2500±200 RPM for two minutes, and that voltage or current is within an appropriate tolerance of the optimum or target values. If the system 100 thereby determines that stable cruise conditions prevail, it adopts the historical-analysis mode and performs historical analysis, as step 114 indicates. Otherwise, the current data's value for comparison purposes is limited, so the system 100 dispenses with the historical analysis. Regardless of mode, the system 100 captures critical aircraft 1000 and fuel-cell and motor performance data periodically (e.g. every three seconds) and records it to a non-volatile computer-readable medium which can be accessed and reviewed at a later time by ground-based personnel, though on-board access and/or review may also be contemplated, as described with relation to FIG. 1.

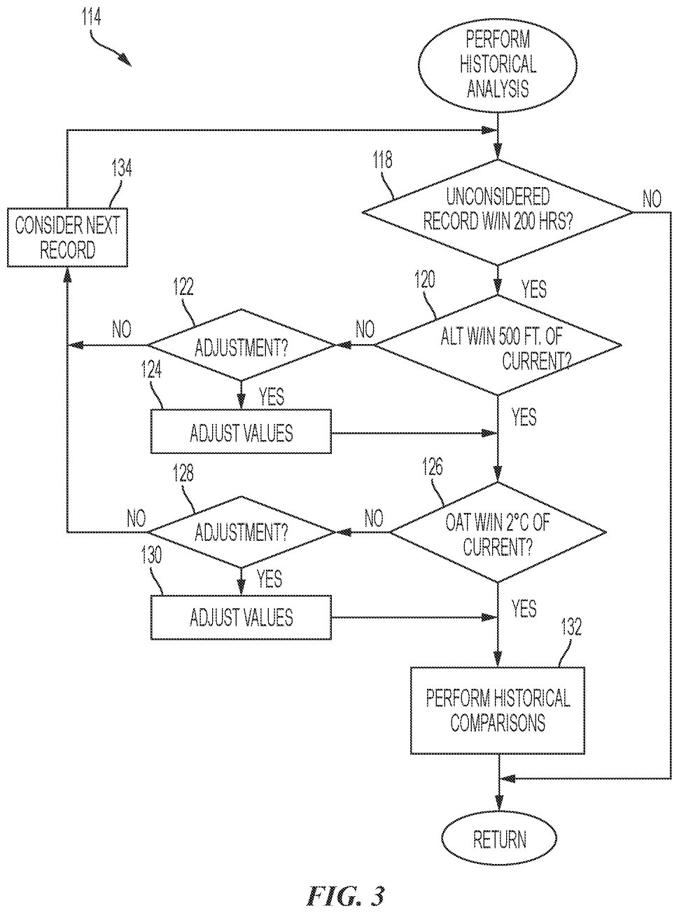

If the determination represented by step 110 was instead that the system was already operating in the normal, cruise-condition regime, the method proceeds to step 116, in which the system 100 determines whether it should now depart from that operating regime. For the example illustrated embodiment, the historical mode is entered only once per flight, such that each flight provides a single record for historical or trend analysis. Thus, step 116 may determine if a historical record for the flight has been obtained. There may be other reasons for which step 116 determines that the historical mode may be departed. Typical reasons for doing so, which indicate that data being taken are not valuable for comparison purposes, are that the rate of altitude change exceeds some maximum, such as 300 feet per minute, or that the air speed has fallen below a certain threshold, such as 70 knots indicated airspeed (kias or KTAS). If such a condition occurs, the system 100 leaves the historical-analysis mode and accordingly dispenses with historical analysis. Otherwise, it performs the step 114 historical analysis, as described in further detail with reference to FIG. 3. Then Step 136 stores analysis results, locally or remotely as previously described herein, making the analysis available for use in future reports, data analysis and comparisons. As the system 100 moves through the steps of the method to process the relevant data using the analysis steps, results (that may comprise current and/or step 114 historical analysis) are updated in memory and data storage as well as updated on crew screens that may comprise primary flight displays 12, or a multi-function display (MFD) 14, thus providing a dynamic health assessment of the aircraft, fuel-cells thereof, and other aircraft components.

FIG. 3 depicts an example flow chart describing operations of FIG. 2 in more detail. Specifically, FIG. 3 depicts actions of step 114 historical analysis. Using the actual values for the performance measures used in making the determination at step 110 of FIG. 2 to enter the historical mode, step 118 of FIG. 3 enters the lookup table or database described in relation to steps 104 and 106 of FIG. 2 to obtain predicted values for other performance measures to be used in the historical analyses, subjecting them to qualification criteria (e.g. within a relevant time elapsed threshold). For the exemplary embodiment, measured values for RPM, altitude and outside air temperature (OAT) may be used as indices in entering the table or database, though other performance measures may be used. The predicted values for the other performance measures are taken or interpolated from the table. For the exemplary embodiment, predicted values may be obtained for FF, OAT true airspeed (KTAS) and % power. Depending on the application, predicted values for other performance measures may be obtained. For example, maximum CHT and maximum EGT may be calculated by curve-fitting against published curves from the fuel-cell manufacturer and adjusted for outside air temperature, as necessary. The historical analysis 114 obtains the differences between the predicted values and the actual values for the performance measures and stores the results in a trend record for the flight. For some parameters, the differences can be taken between a known value for ‘normal’ operating conditions and the actual value. Such ‘normal’ operating condition values, such as oil temperature and pressure, cell operating temperatures and motor temperatures may be obtained from manufacturer's literature. For those performance measures which do not have lookup table or database entries, or cannot be calculated, their actual values as measured during “cruise” conditions are incorporated into the trend record. The system will typically be able to store data for thousands of flight hours, but some embodiments may for some purposes restrict attention to only the most-recent flights (evaluated by accessing predetermined time or quantity of flight settings entered by default or input by a user), particularly to observe trends. Further, in performing historical or trend analyses, it may be beneficial to use a certain minimum number of previous flight records taken during the stable-cruise regime of those previous flights. To represent this, step 118 depicts the system 100 as determining whether there are trend records for least five previous flights that took place within the last 200 hours of flight time. As understood by one of ordinary skill in the art, the number of previous flights and the timing of those flights can be varied to suit the historical and analyses to be performed. The system may refine data sets by evaluating data using additional criteria. For example, step 120 determines whether there are records with altitudes within 500 ft of current altitude measurements, and step 126 determines whether there are records with OAT within 2 degrees C. of current OAT. The method repeatedly applies the sets of criteria, assessing whether adjustment is necessary (for example 122 128 adjustment) based on data and criteria, adjusting values as required at steps 124 and 130 (or displaying indications to perform adjustments) and the method progresses at step 134 to consider the next record as candidate for trend analysis. If there are sufficient trend records that have quantitative ranges with similar aircraft performance, the quantitative ranges of similar aircraft performance are matched with corresponding prior fuel-cell and motor performance to identify a subset of prior fuel-cell and motor performance data. The historical or trend comparisons of fuel-cell and motor performance based on current fuel-cell and motor performance versus the subset of prior fuel-cell and motor performance data are performed, at step 132 and results are returned. As FIG. 3 indicates, no historical comparison occurs if no such records are available. However, in either case, the trend record for the current flight has been stored for possible use in historical analyses of future flights.

The historical comparisons of step 132 may be performed in various ways depending on the performance measure being compared. Generally, a value in the trend record for the current flight is compared to the average of the corresponding value from the trend records for the previous flights, whether the value is a difference value or the actual value of a performance measure. For some measures, the trend record value can also be compared to earlier readings taken from the same flight.

Referring again to FIG. 2, upon completion of the historical analysis, the illustrated embodiment then stores the analysis results, as at step 136, and updates the crew display as necessary, as at step 138. Some embodiments may not employ a crew display, and some may defer some of the analysis and therefore storage of the analysis's results until on-ground apparatus is available for that purpose, or may downlink the data in real time.

When the flight is complete, maintenance personnel can then tap into the recorded data. One approach would be for the ground apparatus to take the form of computers so programmed as to acquire the recorded data, determine the styles of display appropriate to the various parameters, provide the user a list of views among which to select for reviewing the data, and displaying the data in accordance with those views. However, although the illustrated embodiment does rely on ground apparatus to provide the display, it uses the on-board apparatus to generate the list of views and other user-interface elements. As stated above, it does so by utilizing a so-called client-server approach where the on-board apparatus (server) provides web pages; the ground apparatus requires only a standard web-browser client to provide the desired user interface. Other embodiments may allow the on-board system to send emails or text messages detailing key results.

Returning historical analysis or other data analysis may be accomplished in a variety of ways, using various representations in displays to provide that information. In an example embodiment the total plurality of sensors for each subsystem of the aircraft 1000 are linked and aggregated in a comprehensive computer-generated model that establishes a model of the physical aircraft whereby the interaction of the sensor output through the model allow for additional onboard or remote diagnostics. Representations of the model using a graphical user interface may include wireframe or three-dimensional representations that are explorable and can be manipulated to show different views and perspectives of the aircraft while maintaining proportional relationships between graphical representations of sensor and other aircraft elements that accurately reflect the actual distances and configurations of the real sensor devices and aircraft elements in the actual aircraft. Additionally, graphical representations augment the model to readily convey sensor output with audiovisual representations designed to summarize various output measurements (for example, recorded temperature readings at various sensors may be combined to deliver color feedback with differing color values representing different temperature measurements, and areas of anomalous readings or those falling outside predetermined operating thresholds may be highlighted, illuminated, or made to flash in order to call attention to a specific region of the aircraft). The model may be programed to change display parameters and output when various aircraft operating states are altered, such as when a fuel-cell module has been disabled and fuel or power is diverted to other fuel-cell modules to maintain aircraft stability and performance. Wholistic sensor feedback is analyzed from the patterns that emerge across sensor subsets or areas on the model that correspond to actual sensor readings experienced by the aircraft. For example, each fuel-cell component (e.g. individual cells) can be compared to detect weak or weakening cells. The overall set of fuel-cells (e.g. 3 fuel-cells) or the power generation subsystem as a whole can be assessed for performance against historical data, when e.g. running at a known load point. Proximity of anomalous sensor readings mapped onto the model display at a remote or onboard location readily identify potential hazardous situations in the operation of aircraft that would not be as rapidly apparent when referred to each set of sensor data individually. What may ordinarily be undiscernible as signal noise or anomalous sensor readings form a malfunctioning sensor may become apparent, e.g. when several proximal sensors each read increases in temperature (localizing where on the aircraft the temperature as spread to) or when several proximal sensors each provide data indicating unusual motion characteristics around a specific part or subsystem of the aircraft, or when unusual motion or vibrations are readily identified with localized increase in temperature. Representations of the model in onboard displays augment and surpass traditional gauge readings and warning lights in the amount of information provided to occupants.

The redundant systems of the aircraft, which may be networked to monitor themselves and each other with the various sensors and feedback, may be represented by the model to provide even more information as to where potential issues (e.g. each fuel-cell component (e.g. individual cells) can be compared to detect weak or weakening cells), in addition to actual issues (e.g. performance outside of specifications) may be occurring and warrant closer monitoring by onboard or remote means. Additionally, the model enables representation of data for sensor groupings over time as a function of the historical analysis rather than just current sensor output, such that the system 100 can display prior states and changes in data or trend data for comparison, to more readily identify regions of the aircraft 1000 that are behaving dynamically or diverging from steady state or usual operation, allowing for greater anticipation of potential faults before they actually occur (e.g. by observing increasing vibrations over time or reduced velocity during times the aircraft uses the same fuel or generates the same amount of electrical power).

The performance of the model in various model scenarios can be used to identify when emergency procedures or maneuvers may be necessary to prevent flight instability. In this way the model can be used to forecast or predict vehicle performance or operation in conditions the aircraft has yet to travel into, improving the safety and predictability of air travel onboard the aircraft. Instead of providing standard data based on what an ideally functioning or prototypical aircraft would experience, the environmental and situational conditions can be applied to the current state of the particular vehicle, making sensor data processing far more accurate and reliable.

The model in one embodiment might be capable of providing a three-dimensional digital perspective of the aircraft 1000 (including a three-dimensional representation of where the aircraft 1000 is, how it is being operated, and where it is headed) that can illuminate, flag or highlight specific sensor locations to call attention to various occurrences or data related to the plurality of onboard aircraft sensors. The model enables interactive rather than simply passive diagnostics that yield more focused data represented in a more quickly comprehensible display.

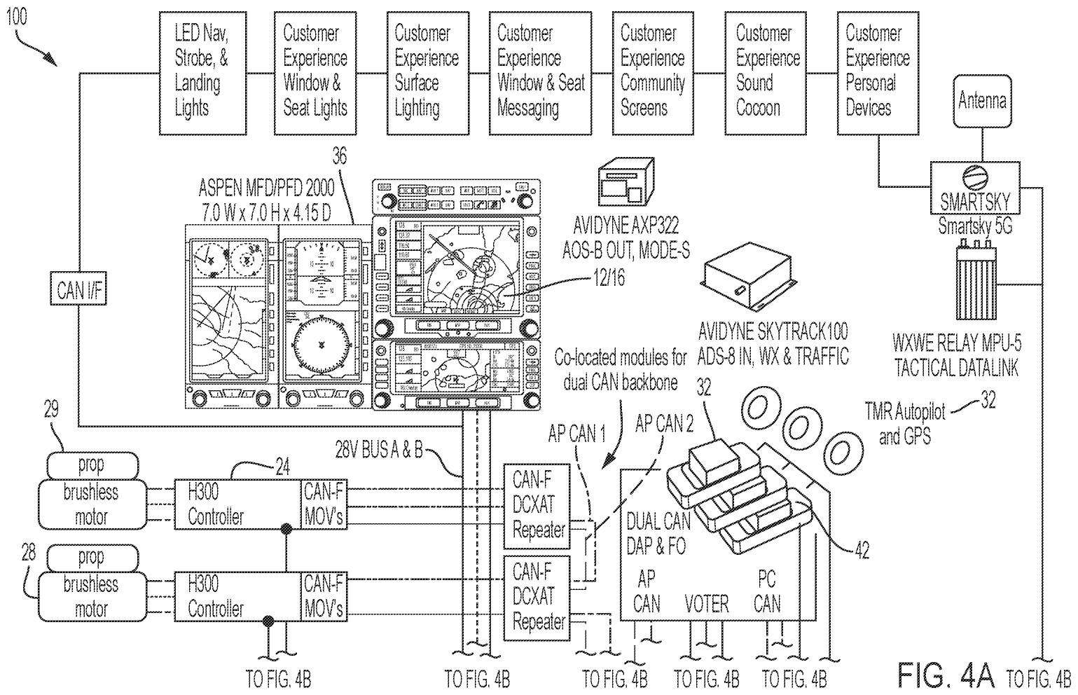

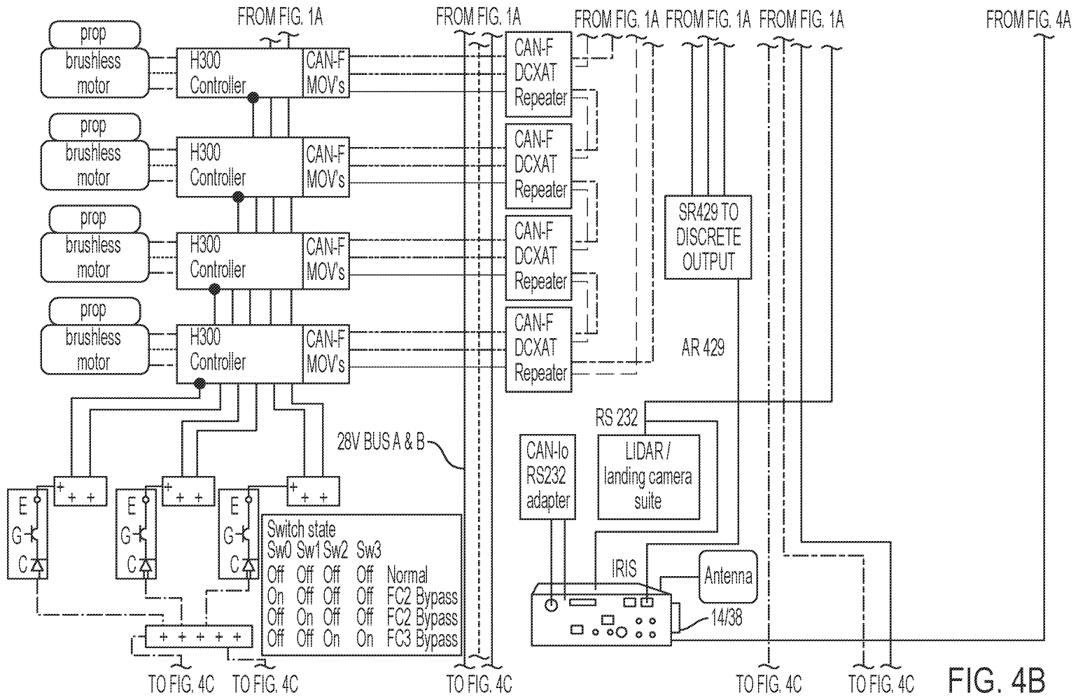

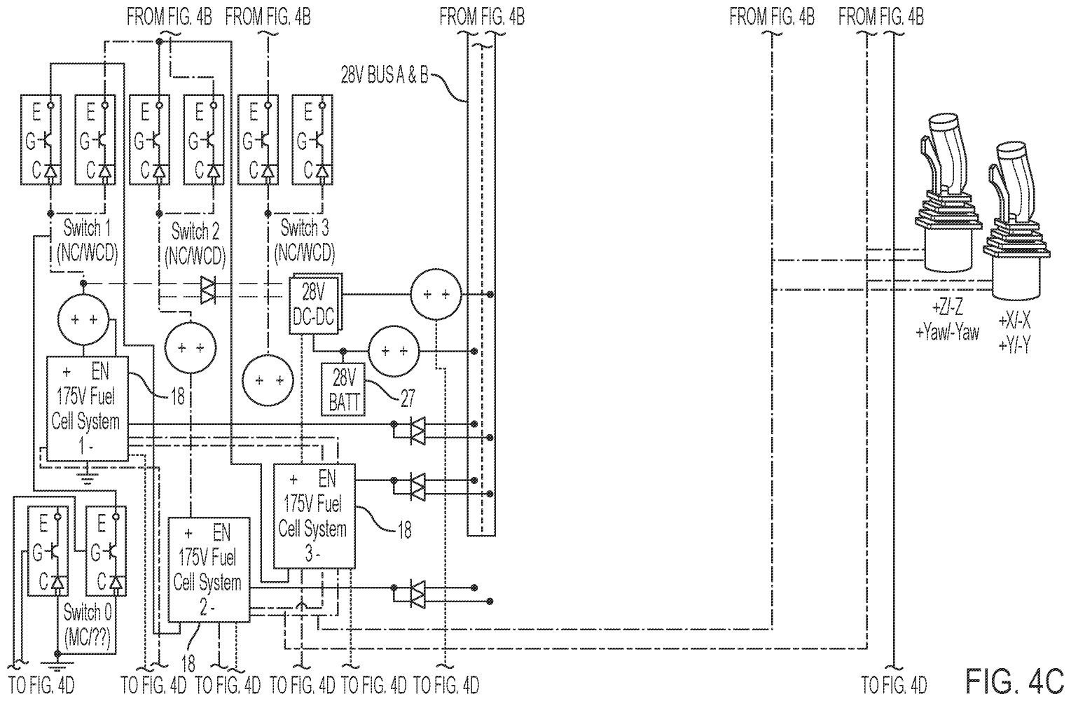

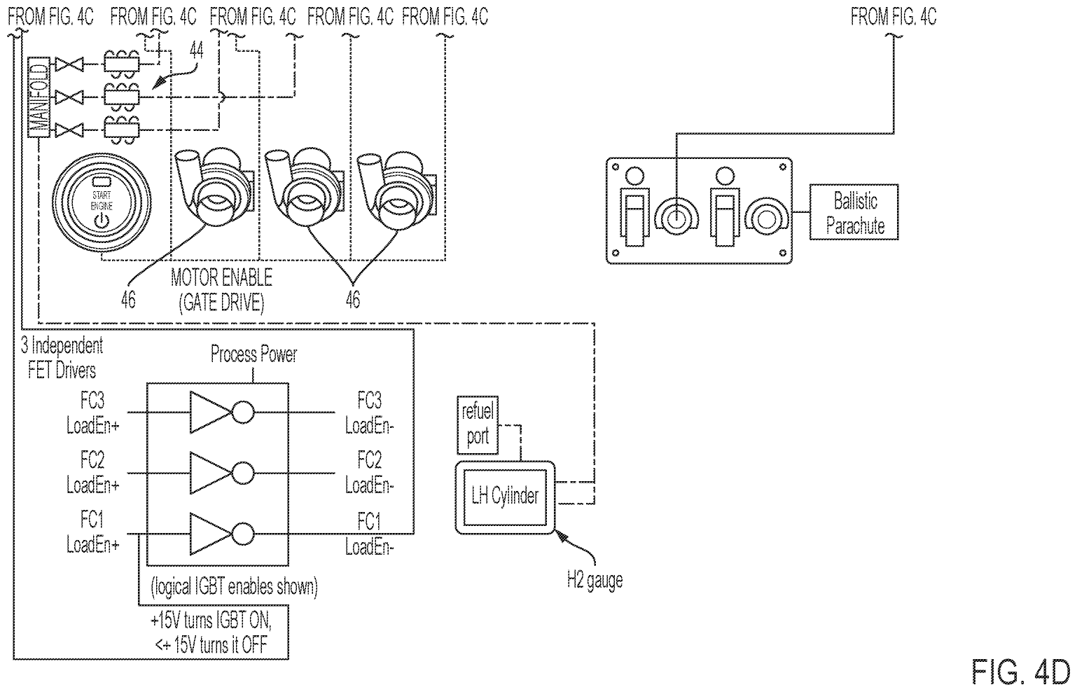

FIGS. 4A-4B depicts an example system block diagram for practicing the present invention, including logic controlling the integrated system and related components based on health assessment. Motors of the multiple motors 28 and propellers 29 or rotors in the preferred embodiment are brushless synchronous three-phase AC or DC motors, capable of operating as an aircraft motor, and that are air-cooled or liquid cooled or both. Motors and fuel-cell modules 18 generate excess or waste heat from forces including electrical resistance and friction, and so this heat may be subject to management and thermal energy transfer. In one embodiment, the motors are connected to a separate cooling loop or circuit from the fuel-cell modules 18. In another embodiment, the motors are connected to a shared cooling loop or circuit with the fuel-cell modules 18.

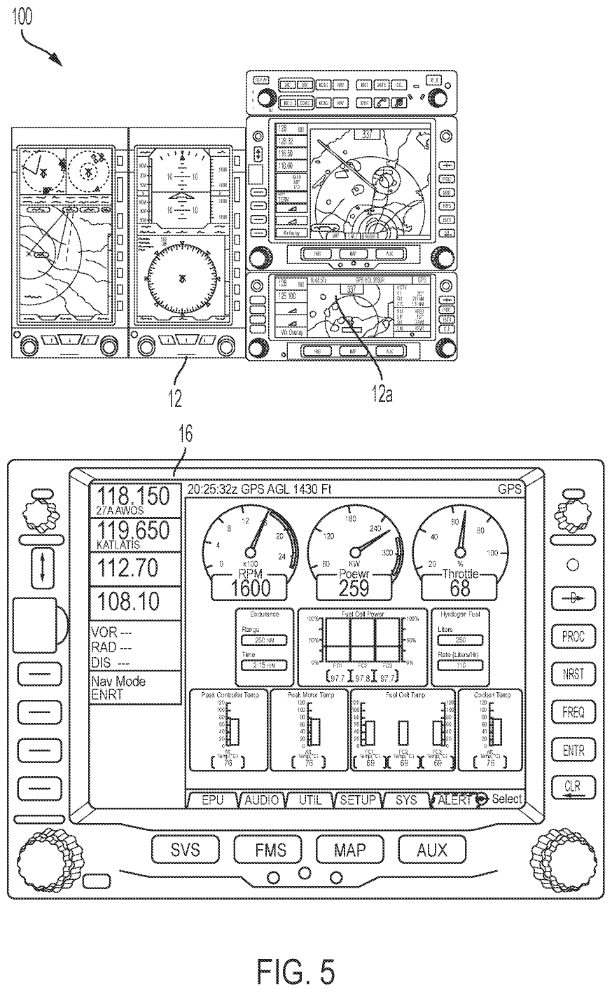

FIG. 5 depicts an example of control panels, gauges and sensor output for the multirotor aircraft 1000. In the illustrated embodiment, the operational analyses and control algorithms described herein are performed by the on-board autopilot computer, and flight path and other useful data are presented on the avionics displays that can include a simplified computer and display with an arrangement of standard avionics used to monitor and display operating conditions, control panels, gauges and sensor output for the clean fuel VTOL aircraft. In one example embodiment one kind of display presentation 16 can be provided to show coolant temperature as well as fuel-cell operating conditions including fuel remaining, fuel-cell temperature and motor performance related to each of the respective motor and propeller or rotor assemblies and fuel-cell modules 18 (bottom) as well as weather data (in the right half) and highway in the sky data (in the left half) derived from electronically connected sensors including temperature sensors. Also shown are the vehicle's GPS airspeed (upper left vertical bar) and GPS altitude (upper right vertical bar). Magnetic heading, bank and pitch are also displayed 12, to present the operator with a comprehensive, three-dimensional representation of where the aircraft 1000 is, how it is being operated, and where it is headed. The lower half of the screen illustrates nearby landing sites that can readily be reached by the vehicle with the amount of power on board. Other screens can be selected from a touch-sensitive row of buttons along the lower portion of the screen, including detailed health assessment displays. Display presentation 12a is similar, but has added ‘wickets’ to guide the pilot along the flight path. The lower half of the screen illustrates nearby landing sites that can readily be reached by the vehicle with the amount of power on board. Common instruments and gauges known in the art that may be incorporated into the display in addition to a magnetic compass or GPS include: an altimeter, an airspeed indicator (e.g. from measuring ram-air pressure in the aircraft's Pitot tube relative to the ambient static pressure), a vertical speed indicator (variometer, or rate of climb indicator) senses changing air pressure, an attitude indicator (artificial horizon) a heading indicator, a directional gyro (DG), a horizontal situation indicator (HSI, which provides heading information, but also assists with navigation) and Attitude Director Indicator (ADI with computer-driven steering bars), a turn indicator or turn-and-slip indicator or turn coordinator (which indicate rotation about the longitudinal axis), an inclinometer (to indicate if the aircraft is in coordinated flight, or in a slip or skid), a very-high frequency omnidirectional range (VOR)/localizer, a course deviation indicator (CDI), an omnibearing selector (OBS), TO/FROM indicator, flags, a nondirectional radio beacon (NDB), an automatic direction finder (ADF) indicator instrument (fixed-card, movable card), a radio magnetic indicator (RMI e.g. that has two needles), or combinations thereof. Many modern instrument clusters integrate several instrument functions (e.g. an RMI remotely coupled to a gyrocompass so that it automatically rotates the azimuth card to represent aircraft heading, coupled to different ADF receivers, allowing for position fixing using one instrument or an HSI that combines the magnetic compass with navigation signals and a glide slope instrument) and the invention is compatible with completely electronic instrumentation displays, including flight glass cockpit instruments primary flight displays (PFD), which are incorporated into the above described avionics displays along with fuel-cell health outputs. FIG. 5 shows the use of available TSO′d (i.e. FAA approved) avionics units, adapted to this vehicle and mission. Subject to approval by FAA or international authorities, a simpler form of avionics (known as Simplified Vehicle Operations or SVO) may be introduced, where said display is notionally a software package installed and operating on a ‘tablet’ or simplified computer and display, similar to an Apple iPad®. The use of two identical units running identical display software allows the user to configure several different display presentations, and yet still have full capability in the event that one display should fail during a flight. This enhances the vehicle's overall safety and reliability.

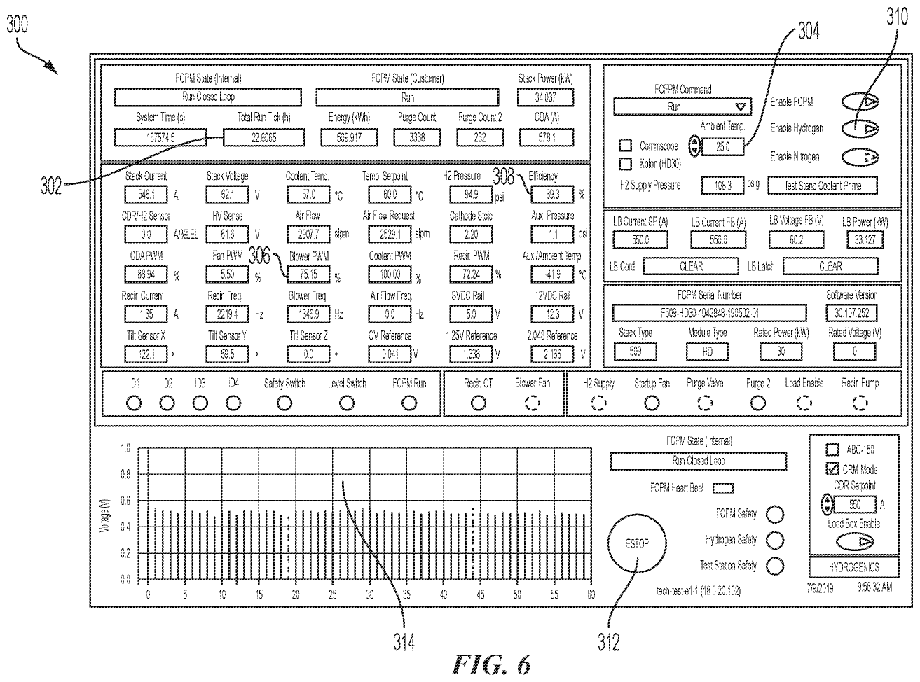

FIG. 6 depicts an example of display output 300 for health assessment and monitoring of performance data derived from onboard sensor output for the multirotor aircraft 1000, including a variety of operational parameters and tolerances to which the historical analysis may be applied. Different embodiments may employ different metrics or criteria, and a given embodiment may use different criteria for different operational parameters or for different types of analysis of the same parameter, e.g., fuel-cell overhaul and changeout. If an anomaly had been detected, the entries that represented the anomalies can be highlighted to notify the maintenance personnel. A representative group of aircraft measurements obtained in this manner may be air speed, altitude, latitude and longitude, outside-air temperature (OAT), the number of propeller or rotor revolutions per minute (RPM), H₂ fuel pressure, fuel-cell temperature and current, the rate of hydrogen consumption or fuel flow (FF), stack current, stack power, stack voltage, module type, rated power, rated voltage, temperature setpoint, efficiency, auxiliary pressure, auxiliary/ambient temperature, 5 vdc rail, 12 vac rail, Tilt sensor, 0 v, 1.25 v, and 2.048 v references air flow. From this data fuel-cell health is measured. The example health assessment display of the system 100 comprises internal timing displays 302, dynamic inputs 304, individual onboard sensor outputs 306, combined metric outputs 308, controls 310, interface components 312 and graphical displays 314. In addition to providing a browser-based communications mode, the on-board system also enables the data to be read in other ways. For example, the on-board storage may also be examined and/or downloaded using the web server interface. Typically, but not necessarily, the on-board storage may take the form of a readily removable device 27, e.g., USB-interface flash-memory, which may contain the data in a comma-delimited or other simple file format easily read by employing standard techniques. The memory device will typically have enough capacity to store data for thousands of hours—possibly, the aircraft's entire service history—so maintenance personnel may be able to employ a ground-based display to show data not only for the most recent flight but also for some selection of previous data, such as the most-recent three flights, the previous ten hours, all data since the last overhaul, the last two hundred hours, or the entire service history, together with indications highlighting anomalies of the type for which the system monitors those data. Other formats for the health assessment can include graphs, text warnings, or other suitable indicators to the pilot, owner, or maintenance personnel.

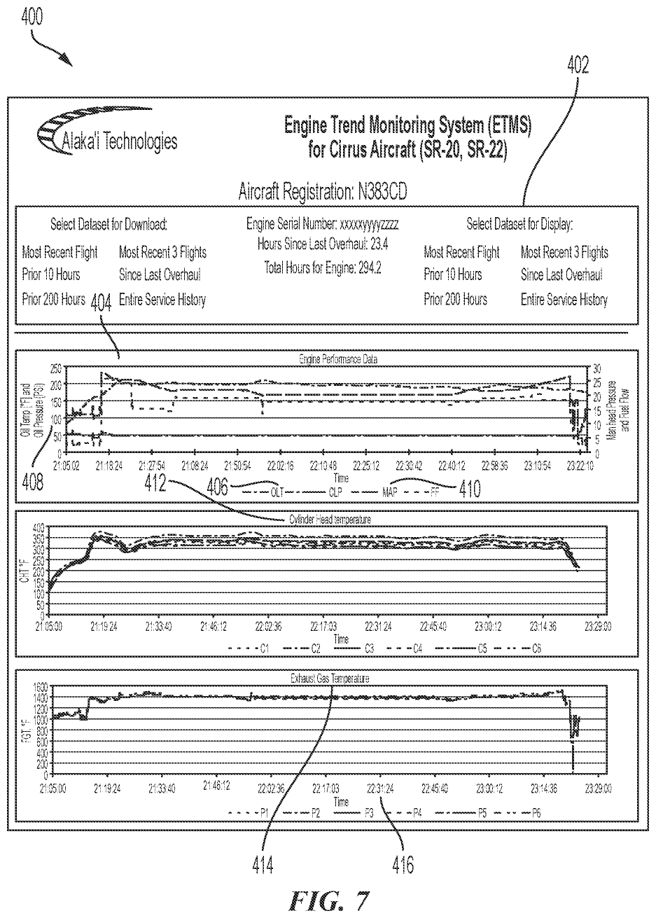

FIG. 7 depicts an example of the type of display 400 that may be used to present some of the data generated by the health assessment and trend monitoring system 100. The parameters and criteria 402 are provided to contextualize the selected data sets analyzed by the system 100. The top plot 404 presents one flight's trend analysis results regarding operational temperature and pressure 408, whereby comparisons have been analyzed for metrics 406 including RPM, MAP, FF, True Airspeed, temperature and pressure, etc. The plot presents temperature and pressure 408 along with MAP and FF 410 etc. as a function of time of day 416. Additional plots display trend data regarding operating temperature 412 and exhaust gas temperature 414. Other views could display other sets of data. As an example, the trend average in plot 404 may be replaced with a series of averages for two or more chronological groupings of the trend records of previous flights.

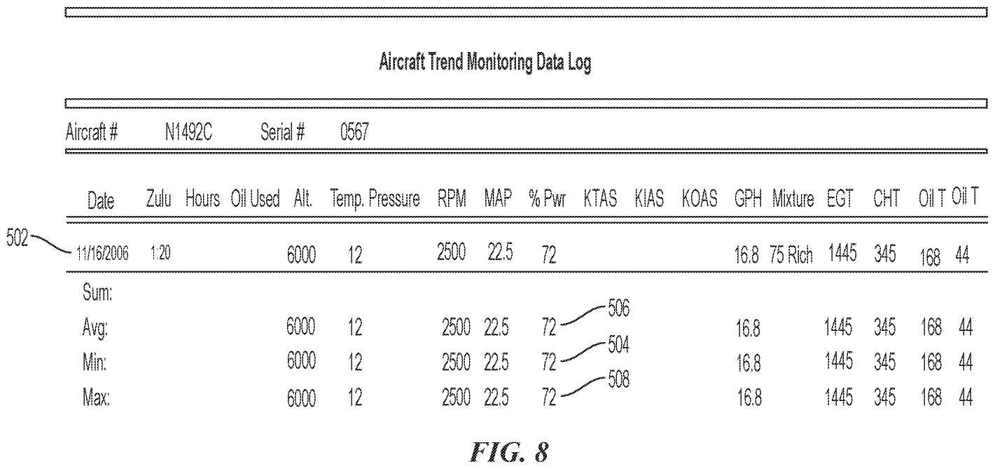

FIG. 8 depicts an example of a data log 500 that may be used in trend monitoring and/or health assessment. FIG. 8 illustrates a comparison between operational parameters for a current flight 502 and average (504), minimum (506) and maximum (508) operational parameters for comparable historical records, as may be determined by historical analysis (step 114 of FIGS. 2 and 3). Use of a log, such as Data Log 500, can facilitate spotting anomalous operating parameters. The log can highlight parameters that are trending towards being out of tolerance, and/or are in fact no longer within acceptable tolerance. Other views may display other sets of data and/or other forms of comparison. For example, comparison plots may be similar to plots 404-410 of FIG. 7, but may show the historical trend for one or more parameters, where a value of the parameter for each record used in the historical analysis may represent a point along the time axis. If the parameters are consistent over time, the comparison plots will show horizontal lines. Any deviation away from horizontal may indicate a trend towards being out of tolerance and can be highlighted to maintenance personnel.

The present invention's approach to analyzing and predicting fuel-cell-related items that can be adjusted or repaired before more-significant maintenance action is required helps avoid more-costly and longer-down-time overhauls and can significantly reduce the probability of a catastrophic in-flight failure. As a result, it makes it possible to reduce maintenance costs for fuel-cell aircraft without impairing (perhaps even enhancing) safety. It therefore constitutes a significant advance and improvement in the art.

FIG. 4 further depicts an example block diagram of electrical systems connectivity and logic for controlling the integrated system and related components. Here, managing power generation for a personal aerial vehicle (PAV) or unmanned aerial vehicle (UAV) includes on-board equipment such as motor 28 and propeller or rotor assemblies 29, primary flight displays 16, cooling source or thermal energy control subsystem an Automatic Dependent Surveillance-B (ADSB) transmitter/receiver, a global-positioning system (GPS) receiver typically embedded within, a fuel gauge, air data computer to calculate airspeed and vertical speed, mission control tablet computers and mission planning software, and redundant flight computers (also referred to as autopilot computers). All of the aforementioned monitor either the operation and position of the aircraft 1000 or monitor and control the hydrogen-powered fuel-cell based power generation subsystem generating electricity and fuel supply subsystems and provide display presentations that represent various aspects of those systems' operation and the aircraft's 1000 state data, such as altitude, attitude, ground speed, position, local terrain, recommended flight path, weather data, remaining fuel and flying time, motor voltage and current status, intended destination, and other information necessary to a successful and safe flight. In an example embodiment, a mission control tablet computer or sidearm controllers may transmit the designated route or position command set or the intended motion to be achieved to autopilot computers 32 and voter 42 motor controllers 24, and air data computer 36 to calculate airspeed and vertical speed. In some embodiments, fuel tank, the avionics battery, the fuel pump and cooling system, and a starter/alternator may also be included, monitored, and controlled. Any fuel-cells are fed by on-board fuel tank and use the fuel to produce a source of power for the multirotor aircraft 1000. The fuel-cell based power generation subsystem combines stored hydrogen with compressed air to generate electricity with a byproduct of only water and heat, thereby forming a fuel-cell module that can also include a fuel pump and cooling system. The system implements pre-designed fault tolerance or graceful degradation that creates predictable behavior during anomalous conditions with respect to at least the following systems and components: 1) flight control hardware; 2) flight control software; 3) flight control testing; 4) motor control and power distribution subsystem; 5) motors; and 6) fuel-cell power generation subsystem. The plurality of motor controllers can be high-voltage, high-current liquid-cooled or air-cooled controllers. The system can further comprise a mission planning computer comprising software, with wired or wireless (RF) connections to the one or more autopilot control units, and a wirelessly connected or wire-connected ADSB unit providing the software with collision avoidance, traffic, emergency detection and weather information to and from the clean fuel aircraft 1000. The one or more autopilot control units comprising a computer processor and input/output interfaces can comprise at least one of interface selected from serial RS232, Controller Area Network (CAN), Ethernet, analog voltage inputs, analog voltage outputs, pulse-width-modulated outputs for motor control, an embedded or stand-alone air data computer, an embedded or stand-alone inertial measurement device. The one or more autopilot control units can operate control algorithms to generate commands to each of the plurality of motor controllers, managing and maintaining multirotor aircraft stability for the clean fuel aircraft, and monitoring feedback. The method can repeat measuring, using one or more temperature sensing devices or thermal energy sensing devices, operating conditions in a multirotor aircraft, and then performs comparing, computing, selecting and controlling, and executing steps using data for the one or more fuel-cell modules to iteratively manage electric voltage and current or torque production and supply by the one or more fuel-cell modules and operating conditions in the multirotor aircraft. The autopilot is also responsible for measuring other vehicle state information, such as pitch, bank angle, yaw, accelerations, and for maintaining vehicle stability using its own internal sensors and available data.

The command interface between the autopilots and the multiple motor controllers will vary from one equipment set to another, and might entail such signal options to each motor controller as a variable DC voltage, a variable resistance, a CAN, Ethernet or other serial network command, an RS-232 or other serial data command, or a PWM (pulse-width modulated) serial pulse stream, or other interface standard obvious to one skilled in the art. Control algorithms operating within the autopilot computer perform the necessary state analysis, comparisons, and generate resultant commands to the individual motor controllers and monitor the resulting vehicle state and stability. Electrical energy to operate the vehicle is derived from the fuel-cell modules, which provide voltage and current to the motor controllers through optional high-current diodes or Field Effect Transistors (FETs) and circuit breakers. The motor controllers each individually manage the necessary voltage and current to achieve the desired thrust by controlling the motor in either RPM mode or torque mode, to enable thrust to be produced by each motor and propeller/rotor combination. The number of motor controllers and motor/propeller or rotor combinations per vehicle may be as few as 4, and as many as 16 or more, depending upon vehicle architecture, desired payload (weight), fuel capacity, electric motor size, weight, and power, and vehicle structure.

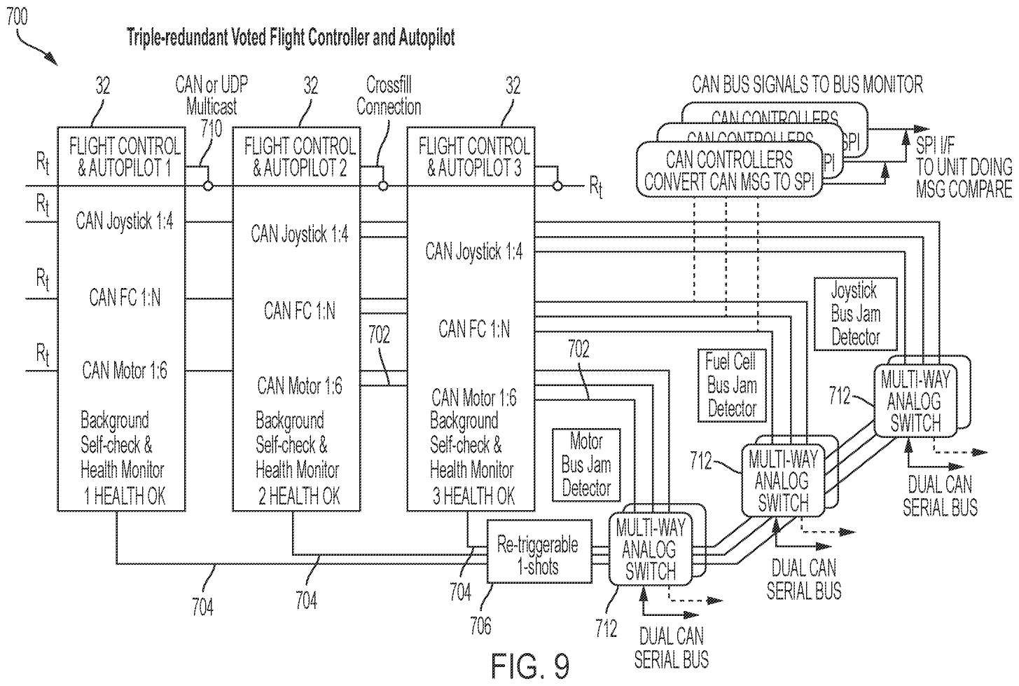

FIG. 9 depicts a block diagram 700 detailing the key features of the redundant, fault-tolerant, multiple-redundant voting control and communications means and autopilot control unit 32 in relation to the overall system. In addition, autopilot computer 32 may also be configured for automatic recording or reporting of aircraft position, aircraft state data, velocity, altitude, pitch angle, bank angle, thrust, location, and other parameters typical of capturing aircraft position and performance, for later analysis or playback. Additionally recorded data may be duplicated and sent to another computer or device that is fire and crash proof. To accomplish these requirements, said autopilot contains an embedded air data computer (ADC) and embedded inertial measurement sensors, although these data could also be derived from small, separate stand-alone units. The autopilot may be operated as a single, dual, quad, or other controller, but for reliability and safety purposes, the preferred embodiment uses a triple redundant autopilot, where the units share information, decisions and intended commands in a co-operative relationship using one or more networks (two are preferred, for reliability and availability). In the event of a serious disagreement outside of allowable guard-bands, and assuming three units are present, a 2-out-of-3 vote determines the command to be implemented by the motor controllers 24, and the appropriate commands are automatically selected and transmitted to the motor controllers 24. Similarly, a subset of hardware monitors the condition of the network, a CAN bus in an example embodiment, to determine whether a bus jam or other malfunction has occurred at the physical level, in which case automatic switchover to the reversionary CAN bus occurs. The operator is not typically notified of the controller disagreement during flight, but the result will be logged so that the units may be scheduled for further diagnostics post-flight.

The mission control tablet computer 36 is typically a single or a dual redundant implementation, where each mission control tablet computer 36 contains identical hardware and software, and a screen button designating that unit as ‘Primary’ or ‘Backup’. The primary unit is used in all cases unless it has failed, whereby either the operator (if present) must select the ‘Backup’ unit through a touch icon, or an automatic fail-over will select the Backup unit when the autopilots detect a failure of the Primary. When operating without a formal pre-programmed route, the mission control tablet computer 36 uses its internal motion sensors to assess the operator's intent and transmits the desired motion commands to the autopilot. When operating without a mission planning computer or tablet, the autopilots receive their commands from the connected pair of joysticks or sidearm controllers. In UAV mode, or in manned automatic mode, the mission planning software 34 will be used pre-flight to designate a route, destination, and altitude profile for the aircraft 1000 to fly, forming the flight plan for that flight. Flight plans, if entered into the Primary mission control tablet computer 36, are automatically sent to the corresponding autopilot, and the autopilots automatically cross-fill the flight plan details between themselves and the Backup mission control tablet computer 36, so that each autopilot computer 32 and mission control tablet computer 36 carries the same mission commands and intended route. In the event that the Primary tablet fails, the Backup tablet already contains the same flight details, and assumes control of the flight once selected either by operator action or automatic fail-over.

For motor control of the multiple motors and propellers 29, there are three phases that connect from each high-current controller to each motor for a synchronous AC or DC brushless motor. Reversing the position of any two of the 3 phases will cause the motor to run the opposite direction. There is alternately a software setting within the motor controller 24 that allows the same effect, but it is preferred to hard-wire it, since the designated motors running in the opposite direction must also have propellers with a reversed pitch (these are sometimes referred to as left-hand vs right-hand pitch, or puller (normal) vs pusher (reversed) pitch propellers, thereby forming the multiple motors and propellers 29. Operating the motors in counter-rotating pairs cancels out the rotational torque that would otherwise be trying to spin the vehicle.

In the illustrated embodiment, the operational analyses and control algorithms described herein are performed by the on-board autopilot computer 32, and flight path and other useful data are presented on the avionics displays 12. Various aspects of the invention can be practiced with a different division of labor; some or all of the position and control instructions can in principle be performed outside the aircraft 1000, in ground-based equipment, by using a broadband or 802.11 Wi-Fi network or Radio Frequency (RF) data-link or tactical datalink mesh network or similar between the aircraft 1000 and the ground-based equipment.

The combination of the avionics display system coupled with the ADSB capability enables the multirotor aircraft 1000 to receive broadcast data from other nearby aircraft, and to thereby allow the multirotor aircraft 1000 to avoid close encounters with other aircraft; to broadcast own-aircraft position data to avoid close encounters with other cooperating aircraft; to receive weather data for display to the pilot and for use by the avionics display system within the multirotor aircraft 1000; to allow operation of the multirotor aircraft 1000 with little or no requirement to interact with or communicate with air traffic controllers; and to perform calculations for flight path optimization, based upon own-aircraft state, cooperating aircraft state, and available flight path dynamics under the National Airspace System, and thus achieve optimal or near-optimal flight path from origin to destination.

FIG. 9 depicts a more detailed example block diagram, showing the voting process that is implemented with the fault-tolerant, triple-redundant voting control and communications means to perform the qualitative decision process. Since there is no one concise ‘right answer’ in this real-time system, the autopilot computers 32 instead share flight plan data and the desired parameters for operating the flight by cross-filling the flight plan, and each measures its own state-space variables that define the current aircraft 1000 state, and the health of each Node. Each node independently produces a set of motor control outputs (in serial CAN bus message format in the described embodiment), and each node assesses its own internal health status. The results of the health-status assessment are then used to automatically select which of the autopilots actually are in control of the motors of the multiple motors and propellers 29.

In an example embodiment, the voting process is guided by the following rules: 1) Each autopilot node (AP) 32 asserts “node ok” 704 when its internal health is good, at the start of each message. Messages occur each update period, and provide shared communications between AP's; 2) Each AP de-asserts “node ok” if it detects an internal failure, or its internal watchdog timer expires (indicating AP or software failure), or it fails background self-test; 3) Each AP's “node ok” signal must pulse at least once per time interval to retrigger a 1-shot ‘watchdog’ timer 706; 4) If the AP's health bit does not pulse, the watchdog times out and the AP is considered invalid; 5) Each AP connects to the other two AP's over a dual redundant, multi-transmitter bus 710 (this may be a CAN network, or an RS-422/423 serial network, or an Ethernet network, or similar means of allowing multiple nodes to communicate); 6) The AP's determine which is the primary AP based on which is communicating with the cockpit primary tablet; 7) The primary AP receives flight plan data or flight commands from the primary tablet; 8) The AP's then crossfill flight plan data and waypoint data between themselves using the dual redundant network 710 (this assures each autopilot (AP) knows the mission or command parameters as if it had received them from the tablet); 9) In the cockpit, the backup tablet receives a copy of the flight plan data or flight commands from its cross-filed AP; 10) Each AP then monitors aircraft 1000 state vs commanded state to ensure the primary AP is working, within an acceptable tolerance or guard-band range (where results are shared between AP's using the dual redundant network 710); 11) Motor output commands are issued using the PWM motor control serial signals, in this embodiment (other embodiments have also been described but are not dealt with in detail here) and outputs from each AP pass through the voter 712 before being presented to each motor controller 24; 12) If an AP de-asserts its health bit or fails to retrigger its watchdog timer, the AP is considered invalid and the voter 712 automatically selects a different AP to control the flight based on the voting table; 13) The new AP assumes control of vehicle state and issues motor commands to the voter 712 as before; 14) Each AP maintains a health-status state table for its companion AP's (if an AP fails to communicate, it is logged as inoperative, and the remaining AP's update their state table and will no longer accept or expect input from the failed or failing AP); 15) Qualitative analysis is also monitored by the AP's that are not presently in command or by an independent monitor node; 16) Each AP maintains its own state table plus 2 other state tables and an allowable deviation table; 17) The network master issues a new frame to the other AP's at a periodic rate, and then publishes its latest state data; 18) Each AP must publish its results to the other AP's within a programmable delay after seeing the message frame, or be declared invalid; and 19) If the message frame is not received after a programmable delay, node 2 assumes network master role and sends a message to node 1 to end its master role. Note that the redundant communication systems are provided in order to permit the system to survive a single fault with no degradation of system operations or safety. More than a single fault initiates emergency system implementation, wherein based on the number of faults and fault type, the emergency deceleration and descent system may be engaged to release an inter-rotor ballistic parachute.

Multi-way voter implemented using analog switch 712 monitors the state of 1.OK, 2.OK and 3.OK and uses those 3 signals to determine which serial signal set 702 to enable so that motor control messages may pass between the controlling node and the motor controllers 24, fuel-cell messages may pass between the controlling node and the fuel-cells, and joystick messages may pass between the controlling node and the joysticks. This controller serial bus is typified by a CAN network in the preferred embodiment, although other serial communications may be used such as PWM pulse trains, RS-232, Ethernet, or a similar communications means. In an alternate embodiment, the PWM pulse train is employed; with the width of the PWM pulse on each channel being used to designate the percent of RPM that the motor controller 24 should achieve. This enables the controlling node to issue commands to each motor controller 24 on the network. Through voting and signal switching, the multiple (typically one per motor plus one each for any other servo systems) command stream outputs from the three autopilot computers can be voted to produce a single set of multiple command streams, using the system's knowledge of each autopilot's internal health and status.

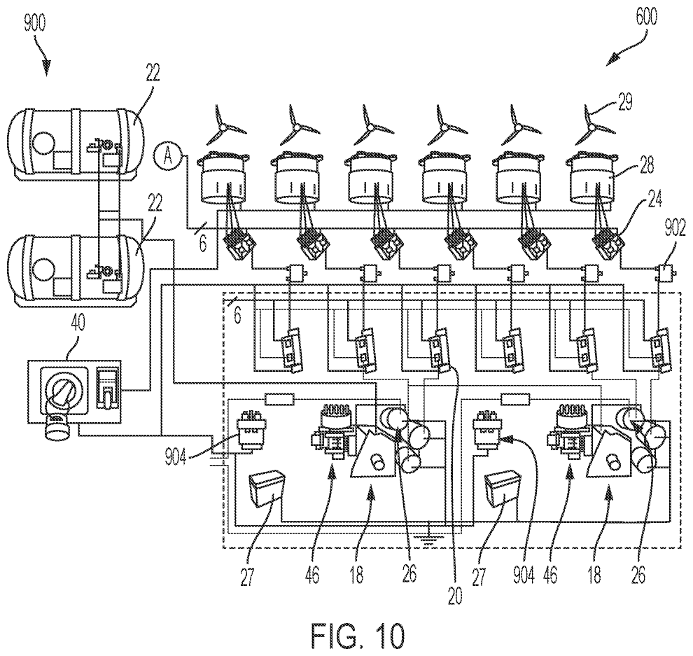

FIG. 10 depicts electrical and systems connectivity of various fuel-cell, oxygen delivery, fuel supply, power generation, and motor control components of a system of the invention, as well as an example fuel supply subsystem 900 for the multirotor aircraft 1000. The electrical connectivity includes six motor and propeller assemblies 28 (of a corresponding plurality of motors and propellers 29 or rotors) and the electrical components needed to supply the motor and propeller combinations with power. A high current contactor 904 is engaged and disengaged under control of the vehicle key switch 40, which applies voltage to the starter/generator 26 to start the fuel-cell modules 18. In accordance with an example embodiment of the present invention, after ignition, the fuel-cell modules 18 (e.g., one or more hydrogen-powered fuel-cells or hydrocarbon-fueled motors) create the electricity to power the six motor and propeller assemblies 28 (of multiple motors and propellers 29). A power distribution monitoring and control subsystem with circuit breaker 903 autonomously monitors and controls distribution of the generated electrical voltage and current from the fuel-cell modules 18 to the plurality of motor controllers 24. As would be appreciated by one skilled in the art, the circuit breaker 902 is designed to protect each of the motor controllers 24 from damage resulting from an overload or short circuit. The oxygen delivery system 1100 tanks or cannisters 92 (that may be implemented as multiple tanks or inner tanks depending on aircraft configuration) are electrically connected to control actuation and dispensing rates using various controls and valves known to those of ordinary skill in the art. Additionally, the electrical connectivity and fuel supply subsystem 900 includes diodes or FETs 20, providing isolation between each electrical source and an electrical main bus and the fuel-cell modules 18. The diodes or FETs 20 are also part of the fail-safe circuitry, in that they diode-OR the current from the two sources together into the electrical main bus. For example, if one of the pair of fuel-cell modules 18 fails, the diodes or FETs 20 allow the current provided by the now sole remaining current source to be equally shared and distributed to all motor controllers 24. Such events would clearly constitute a system failure, and the autopilot computers 32 would react accordingly to land the aircraft safely as soon as possible.

Advantageously, the diodes or FETs 20 keep the system from losing half its motors by sharing the remaining current. Additionally, the diodes or FETs 20 are also individually enabled, so in the event that one motor fails or is degraded, the appropriate motor and propeller combinations 28 (of multiple motors and propellers 29, e.g. the counter-rotating pair) would be disabled. For example, the diodes or FETs 20 would disable the enable current for the appropriate motor and propeller combinations 28 (of multiple motors and propellers 29 or rotors) to switch off that pair and avoid imbalanced thrust. Similarly, the oxygen delivery system 1100 can be automatically engaged or triggered to increase power output in the event of such a failure. In this way additional power through current can be quickly supplied to the remaining operational motor and propeller combinations 28 (of multiple motors and propellers 29 or rotors) such that vehicle performance and flight parameters are maintained despite a failure event. In accordance with an example embodiment of the present invention, the six motor and propeller combinations 28 (of multiple motors and propellers 29) each include a motor and a propeller 29 and are connected to the motor controllers 24, that control the independent movement of the six motors of the six motor and propeller combinations 28. As would be appreciated by one skilled in the art, the electrical connectivity and fuel supply subsystem 900 may be implemented using 6, 8, 10, 12, 14, 16, or more independent motor controllers 24 and the motor and propeller assemblies 28 (of a plurality of motors and propellers 29).

Continuing with FIG. 10, the electrical connectivity and fuel supply subsystem 900 also depicts the redundant battery module system as well as components of the DC charging system. The electrical connectivity and fuel supply subsystem 901 includes the fuel tank 22, the avionics battery 27, the pumps (e.g. water or fuel pump) and cooling system 44, the supercharger 46, and a starter/alternator. The fuel-cells 18 are fed by on-board fuel 30 tank 22 and use the fuel to produce a source of power for the motor and propeller combinations 28. As would be appreciated by one skilled in the art, the fuel-cell modules 18 can include one or more hydrogen-powered fuel-cells can be fueled by hydrogen or other suitable gaseous fuel 30, to drive or turn multiple motors and propellers 29.

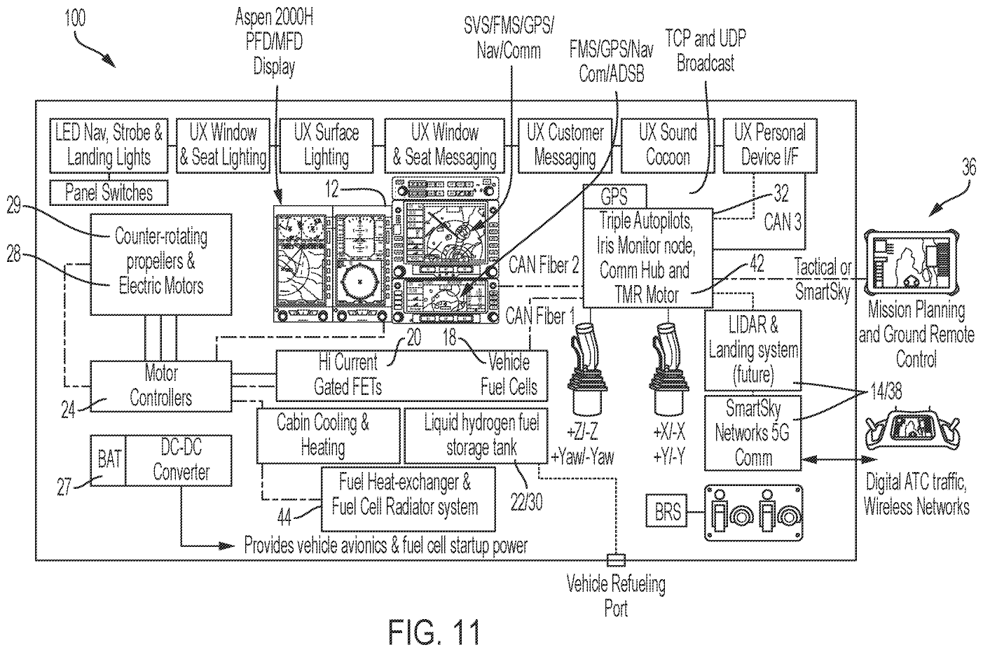

FIG. 11 depicts an example system diagram of electrical and systems connectivity for various control interface components of a system of the invention, including logic controlling the generation, distribution, adjustment and monitoring of electrical power (voltage and current). Pairs of motors for the multiple motors 28 and propellers 1006 or rotors are commanded to operate at different RPM or torque settings (determined by whether the autopilot is controlling the motors in RPM or torque mode) to produce slightly differing thrust amounts from the pairs of counter-rotating motors and propellers 1006 or rotors under autopilot control, thus imparting a pitch moment, or a bank moment, or a yaw moment, or a change in altitude, or a lateral movement, or a longitudinal movement, or simultaneously any combination of the above to the aircraft 1000, using position feedback from the autopilot's 6-axis built-in or remote inertial sensors to maintain stable flight attitude. Sensor data is read by each autopilot to assess its physical motion and rate of motion, which is then compared to commanded motion in all three dimensions to assess what new motion commands are required. Depending on the equipment and protocols involved in the example embodiment, a sequence of commands may be sent using a repeating series of servo control pulses carrying the designated command information, represented by pulse-widths varying between 1.0 to 2.0 milliseconds contained within a ‘frame’ of, for example, 10 to 30 milliseconds). In this way, multiple channels of command information are multiplexed onto a single serial pulse stream within each frame. The motor's RPM is determined by the duration of the pulse that is applied to the control wire. In another embodiment, motor commands may be transmitted digitally from the autopilot to the motor controllers 24 and status and/or feedback may be returned from the motor controllers 24 to the autopilot using a digital databus such as Ethernet or CAN (Controller Area Network), one of many available digital databusses capable of being applied. When combined with avionics, instrumentation and display of the aircraft's 1000 current and intended location, the set of equipment enables the operator, whether inside the vehicle, on the ground via datalink, or operating autonomously through assignment of a pre-planned route, to easily and safely operate and guide the aircraft 1000 to its intended destination. Electrical operating characteristics/data for each motor are controlled and communicated to the voting system for analysis and decision making. Communication to the motor controllers 24 happens (in this embodiment) between autopilot and motor controller 24 via CAN, a digital network protocol, with fiber optic transceivers inline to protect signal integrity. Flight control hardware may comprise, for example, a redundant set of flight controllers with processors, where each comprises: three (3) Accelerometers, three (3) gyros, three (3) magnetometers, two (2) barometers, and at least one (1) GPS device, although the exact combinations and configurations of hardware and software devices may vary. Measured parameters related to motor performance include motor temperature, IGBT temperature, voltage, current, torque, and revolutions per minute (RPM). Values for these parameters in turn correlate to the thrust expected under given atmospheric, power and pitch conditions.

The fuel-cell control system may have various numbers of fuel-cells based on the particular use configuration, for example a set of three hydrogen fuel-cells configured for fault-tolerance. One or more flight control algorithms stored within the autopilot will control and monitor the power delivered by the fuel-cells via CAN. The triple-modular redundant auto-pilot can detect the loss of any one fuel-cell and reconfigure the remaining fuel-cells using a form of cross connection, thus ensuring that the fuel-cell and motor system is capable of continuing to operate the aircraft 1000 to perform a safe descent and landing.

The combination of the avionics display system coupled with the ADSB capability enables the multirotor aircraft 1000 to receive broadcast data from other nearby aircraft, and to thereby allow the multirotor aircraft 1000 to avoid close encounters with other aircraft; to broadcast own-aircraft position data to avoid close encounters with other cooperating aircraft; to receive weather data for display to the pilot and for use by the avionics display system within the multirotor aircraft 1000; to allow operation of the multirotor aircraft 1000 with little or no requirement to interact with or communicate with air traffic controllers; and to perform calculations for flight path optimization, based upon own-aircraft state, cooperating aircraft state, and available flight path dynamics under the National Airspace System, and thus achieve optimal or near-optimal flight path from origin to destination.

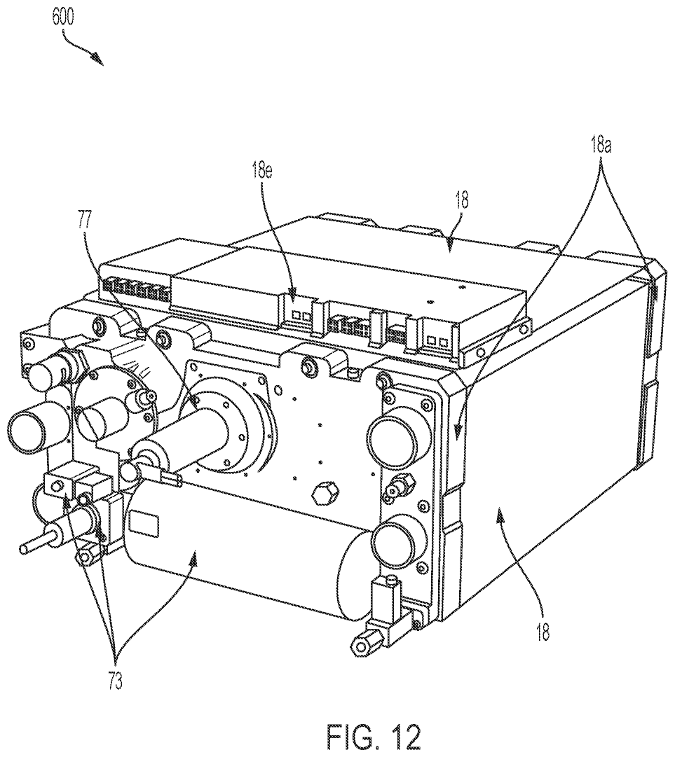

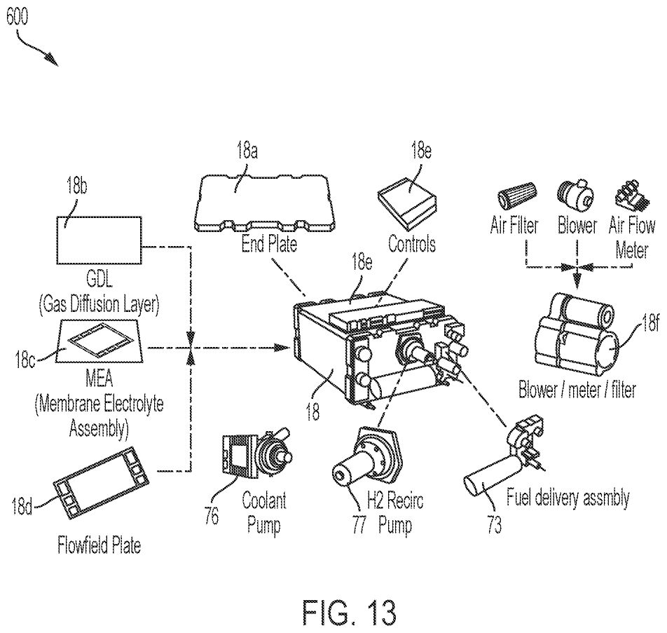

FIGS. 12, 13 and 14 depict example subcomponents of fuel-cell modules 18 within the power generation subsystems 600 of the multirotor aircraft 1000. FIG. 12 depicts example configurations of fuel-cells within the multirotor aircraft 1000, including subcomponents of fuel-cells in at least one fuel-cell module within the power generation subsystems of the multirotor aircraft 1000. In one embodiment, an aviation fuel-cell module comprises one or more hydrogen-powered fuel-cells, where each hydrogen-powered fuel-cell is fueled by gaseous hydrogen (GH₂) or liquid hydrogen (LH₂), a multi-function stack end plate comprising an integrated manifold, air filters, blower, airflow meter, fuel delivery assembly, recirculation pump, coolant pump, fuel-cell controls, sensors, end plate, at least one gas diffusion layer (GDL), at least one membrane electrolyte assembly, anode and cathode volumes on each side of a proton exchange membrane of the membrane electrolyte assembly with backing layers and catalyst layers, at least one flowfield plate, fluid coolant conduits, connections or junctions, a hydrogen inlet, a coolant inlet, a coolant outlet, one or more air-driven turbochargers, and coolant conduits connected to and in fluid communication with the one or more fuel-cell modules and transporting fluid coolant 118, an integrated wiring harnesses, integrated electronics and controls. FIG. 13 depicts example subcomponents of fuel-cells in at least one fuel-cell module 18 within the multirotor aircraft 1000. In one embodiment the one or more fuel-cell modules 18 comprise an air filter 18f, blower 18f, airflow meter 18f, fuel delivery assembly 73, recirculation pump 77, coolant pump 76, fuel-cell controls 18e, sensors, end plate 18a, at least one gas diffusion layer 18b, at least one membrane electrolyte assembly 18c, at least one flowfield plate 18d, coolant conduits 84, connections, a hydrogen inlet 82, a coolant inlet 78, a coolant outlet 79, one or more air-driven turbochargers 46 supplying air to the one or more fuel-cell modules 18, and coolant conduits 84 connected to and in fluid communication with the one or more fuel-cell modules 18 and transporting coolant 31. The one or more fuel-cell modules 18 may further comprise one or more hydrogen-powered fuel-cells, where each hydrogen-powered fuel-cell is fueled by gaseous hydrogen (GH₂) or liquid hydrogen (LH₂) and wherein the one or more fuel-cell modules 18 combines hydrogen from the fuel tank 22 with air to supply electrical voltage and current. Fuel-cell vessels and piping are designed to the ASME Code and DOT Codes for the pressure and temperatures involved.

In one embodiment, an aviation fuel-cell module 18 comprises a multi-function stack end plate that is configured for reduced part count, comprising an integrated manifold, an integrated wiring harnesses, integrated electronics and controls, wherein the stack end plate eliminates certain piping and fittings and allows easier part inspection and replacement, yielding improved reliability, significant mass, volume and noise reduction, and reduction in double wall protection. The integrated electronics and controls may operate as temperature sensors or thermal energy sensors for the fuel-cell modules 18, and may also be integrated into the heat transfer infrastructure architecture of the fuel-cell modules 18 such that the excess heat generated by operation may also be transferred away from the electronics and controls to promote more efficient operation and reduce overheating. The aviation fuel-cell module 18 may be further configured of aerospace lightweight metallic fuel-cell components, with a stack optimized for: reduced weight; increased volumetric power density; extreme vibration tolerance; improved performance and fuel efficiency; increased durability; and combinations thereof. In an example embodiment, a fuel-cell module 18 may produce 120 kW of power, in a configuration with dimensions of 72×12×24 inches (L×H×W) and a mass of less than 120 kg, with a design life greater than 10,000 hours. The operation orientation of each module accommodates roll, pitch, and yaw, as well as reduction in double wall protection and shock & vibration system tolerance.

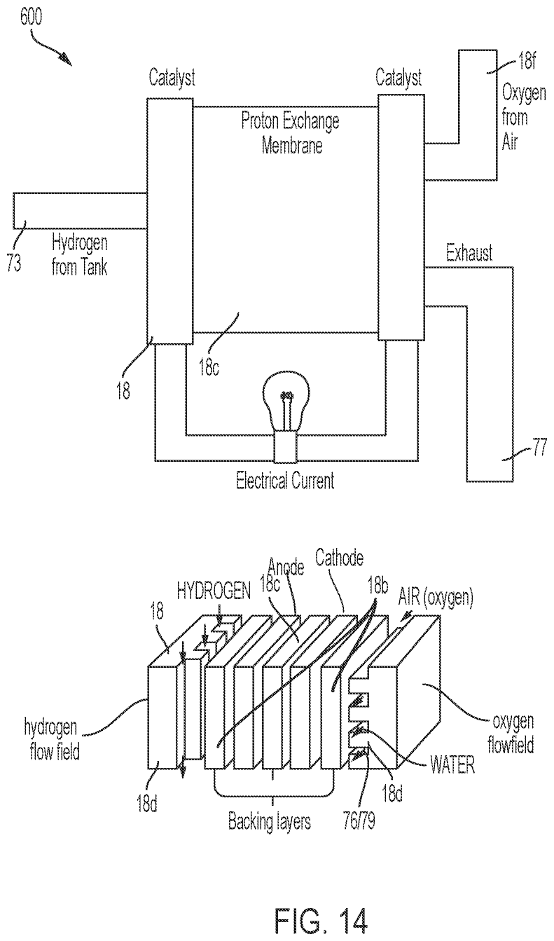

FIG. 14 depicts example internal subcomponents of fuel-cells within the fuel-cell modules 18 covered by an end plate 18a, demonstrating the configuration of hydrogen flowfield plates and oxygen flowfield plates 18d, anode and cathode volumes on each side of the proton exchange membrane 18c of the membrane electrolyte assembly with backing layers and catalysts, as well as resulting hydrogen, oxygen, and coolant flow vectors. Gaseous hydrogen fuel may enter via a delivery assembly 73, oxygen (O₂), in the form of compressed air (supplied by turbochargers or superchargers 46, blowers or local supply of compressed air or oxygen) may enter as output from an air filter/blower/meter 18f, and exhaust fluids can be removed via recirculation pump 77. In one embodiment, catalyst layers may be adhered at the electrode/electrolyte interface. Liquid water may be formed at the cathode in the catalyst layer at the electrode/electrolyte interface, which hinders fuel-cell and motor performance when not removed, where it hinders O₂ from getting to electrode/electrolyte interface, causing limitations in max current density. A Gas diffusion layer GDL 18b may be implemented to permit H₂O to be removed without hindering gas transport. The GDL 18b may be porous to permit flow to the electrode/electrolyte interface & sufficient conductivity to carry the current generated and allow water vapor diffusion through the GDL18b and convection out the gas outflow channels, thereby circulating electrolyte and vaporizing water, but not be liquid H₂O permeable. A Gas diffusion layer GDL 18b may be electrically conductive to pass electrons between the conductors that make up the flow channels. A GDL 18b may comprise both a backing layer and mesoporous layer. Compressed O₂/air also flows through gas flow channels, diffuses through a GDL18b, to a catalyst layer where it then reacts with ions or protons coming through an electrolyte layer or assembly. Common electrolyte types include alkali, molten carbonate, phosphoric acid (liquid electrolytes), as well as proton exchange membrane (PEM 18c) and solid oxide (solids). Liquid electrolytes are held between the two electrodes by various means. A PEM 18c is held in place using membrane electrolyte assembly (MEA) 18c. A PEM 18c (PEMFC) most often uses a water-based, acidic polymer membrane as its electrolyte, with platinum-based electrodes.

In operation, LH₂ converted to GH₂ by extraction using one or more heat exchangers 57 or by change in pressure initiated by the system 100, and a compressed air/O₂ flow from turbochargers or superchargers 46 (or conventional fuel pumps and regulators or local storage of air or oxygen) by way of an air filter/blower/meter 18f, are both supplied to one or more fuel-cell modules 18 that comprise one or more fuel-cell stacks containing a plurality of hydrogen fuel-cells. In each fuel-cell of the plurality of hydrogen fuel-cells GH₂ fuel from a delivery assembly 73 enters a first end of a hydrogen flowfield plate 18d inflow at an inlet and is fed through flow channels in the hydrogen flowfield plate 18d that comprise a channel array designed to distribute and channel hydrogen to an anode layer, where excess GH₂ may be directed to bypass the rest of the fuel-cell and exit a second end of that flowfield plate 18d via GH₂ outflow at an outlet that may be further connected to and in fluid communication with fluid conduits, valves and recirculation pumps 77 to recycle the hydrogen for future fuel-cell reactions (or may be vented as exhaust using an exhaust port 66). Similarly, in each fuel-cell O₂ contained within or extracted from compressed air from a turbocharger or supercharger 46 enters a first end of oxygen flowfield plate 18d inflow using an inlet and is fed through flow channels traversing the flowfield plate 18d in a direction at a perpendicular angle to the flow of GH₂ in the respective opposite flowfield plate 18d of the pair of plates in each fuel-cell, through a channel array designed to distribute and channel oxygen to a cathode layer, where excess O₂ may be directed to bypass the rest of the fuel-cell and exit a second end of that flowfield plate 18d via O₂ and/or H₂O outflow at an outlet that may be further connected to and in fluid communication with fluid conduits, valves and recirculation pumps 77 to recycle the oxygen for future fuel-cell reactions (or may be vented as exhaust using an exhaust port 66). Each of the gases GH₂ and O₂ are diffused through two distinct GDLs 18b disposed on both sides of the fuel-cell opposite each other (such that net flow is toward each other and the center of the fuel-cell), separated by two layers of catalyst further separated by plastic membrane such as a PEM 18c. An electro-catalyst, which may be a component of the electrodes at the interface between a backing layer and the plastic membrane catalyst, splits GH₂ molecules into hydrogen ions or protons and electrons using a reaction that may include an oxidation reaction. In one embodiment, at the anode of an anode layer, a platinum catalyst causes the H₂ dihydrogen is split into H+ positively charged hydrogen ions (protons) and e− negatively charged electrons. The PEM 18c allows only the positively charged ions to pass through it to the cathode, such that protons attracted to the cathode pass through PEM 18c while electrons are restricted where the PEM electrolyte assembly (MEA) acts as a barrier for them. The negatively charged electrons instead travel along an external electrical circuit to the cathode, following a voltage drop, such that electrical current flows from anode side catalyst layer to cathode side catalyst layer creating electricity to power the aircraft 1000 components that is directed to storage or directly to a plurality of motor controllers 24 to operate a plurality of motor and propeller assemblies 28. At contact with the platinum electrode as the electrons pass through the GDL after being distributed by flowfield plate 18d, one or more current collectors may be employed to facilitate flow of electrons into the external electrical circuit, which may be comprised of metallic or other suitable conductive media and directed to circumvent the MEA and arrive at the cathode layer. After traveling through the external electrical circuit electrons are deposited at the cathode layer where electrons and hydrogen ions or protons with O₂ in the presence of a second catalyst layer to generate water and heat. Electrons combine with O₂ to produce O₂ ions and then hydrogen ions or protons arriving through the PEM 18c combine with the ions of O₂ to form H₂O. This H₂O is then transported back across the cathode side catalyst layer through a GDL into O₂ flow channels where it can be removed or otherwise convected away with air flow to exit a second end of that flowfield plate 18d via O₂ and/or H₂O outflow at an outlet that may be further connected to and in fluid communication with fluid conduits, valves, or pumps and may be vented as exhaust using an exhaust port 66 that may be used for other exhaust gases or fluids as well. Thus, the products of the fuel-cells are only heat, water, and the electricity generated by the reactions. In other embodiments, additional layers may alternatively be implemented such as current collector plates or GDL compression plates.

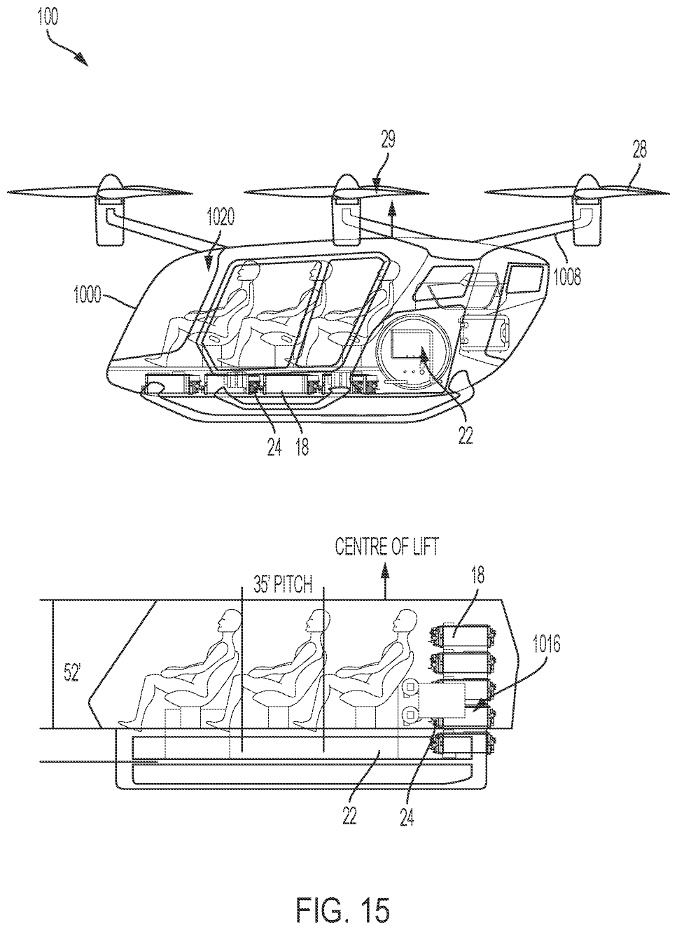

FIG. 15 depicts profile diagrams of the multirotor aircraft 1000 demonstrating example positions of fuel health assessment and monitoring system components and power generation subsystems within the multirotor aircraft as well as heat transfer and heat exchange components comprising cooling bodies, and systems connectivity of various fuel supply, power generation, and motor control components of the invention. Onboard sensors embedded in these components redundantly monitor each other and provide the health assessment system with current data on the performance, state and operating conditions of the aircraft 1000.

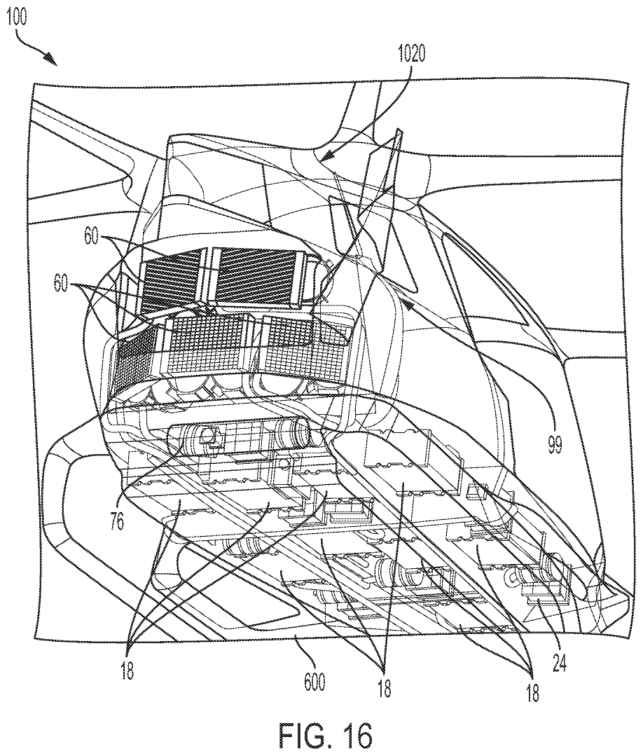

FIG. 16 depicts an example diagram of the configuration of power generation subsystem heat transfer and exchange components, including onboard sensors, within the multirotor aircraft that depicts two views demonstrating the position and compartments housing the fuel supply and power generation subsystems depicting coolant fluid conduits. Example embodiments of the configuration of power generation subsystem including heat transfer and cooling source 1010 components within the multirotor aircraft 1000 that depicts views demonstrating the position and compartments housing the fuel supply and power generation subsystems together with coolant fluid conduits 142. The power generation subsystem may have various numbers of fuel-cells based on the particular use configuration, for example a set of hydrogen fuel-cells. Operation and control of the cells is enabled via CAN protocol or a similar databus or network or wireless or other communications means. Flight control algorithm will modulate and monitor the power delivered by fuel-cells via CAN. Onboard sensor data for the relevant components is analyzed by the system 100 and based on that analysis, autopilot control units operate and control the fuel-cells via CAN protocol or a similar databus or network or wireless or other communications means to operate the aircraft 1000 within specifications and acceptable operating parameters.

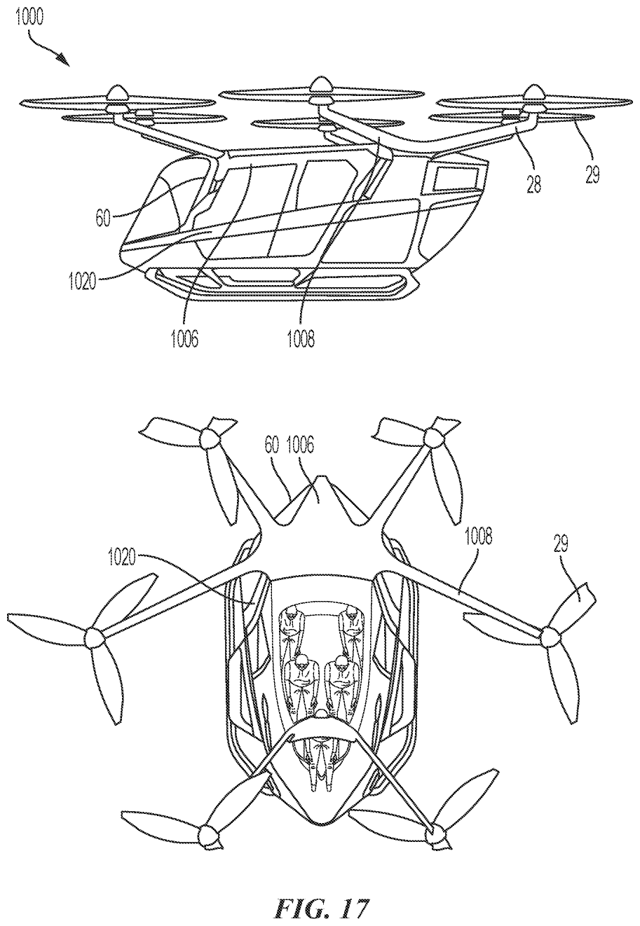

FIG. 17 depicts side and top views of a multirotor aircraft with six rotors cantilevered from the frame of the multirotor aircraft in accordance with an embodiment of the present invention, indicating the location and compartments housing the fuel supply and power generation subsystems; electrical and systems connectivity of various fuel supply, power generation, and motor control components of a system of the invention; demonstrating the position of the array of propellers or rotors 29 extending from the frame of the multirotor aircraft airframe 100 and elongate support arms 1008 with an approximately annular configuration. In accordance with an example embodiment of the present invention, the multiple electric motors 28 are supported by the elongate support arms 1008, and when the aircraft 1000 is elevated, the elongate support arms 1008 support (in suspension) the aircraft 1000 itself. Side and top views of a multirotor aircraft 1000 depict six rotors (propellers 29) cantilevered from the frame of the multirotor aircraft 1000 in accordance with an embodiment of the present invention, indicating the location of the airframe 1000, attached to which are the elongate support arms 1008 that support the plurality of motor 28 and propeller or rotor 29 assemblies wherein the cooling bodies 60 are clearly shown.

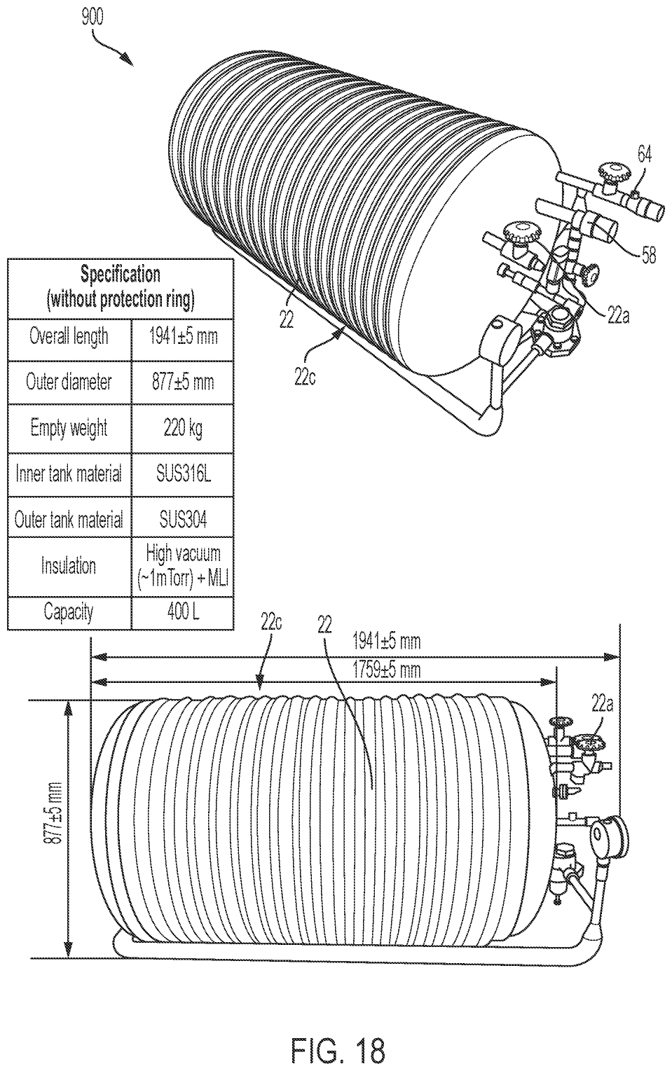

FIG. 18 depicts example subcomponents of fuel tanks 22 and fuel supply subsystem 900 within the multirotor aircraft 1000, complete with sensors providing data for health assessment of the aircraft 1000. The fuel tank 22 further comprises a carbon fiber epoxy shell or a stainless steel or other robust shell, a plastic or metallic liner, a metal interface, crash/drop protection, and is configured to use a working fluid of hydrogen as the fuel 30 with fuel lines 85, vessels and piping 85 designed to the ASME Code and DOT Codes for the pressure and temperatures involved. Generally, in a thermodynamic system, the working fluid is a liquid or gas that absorbs or transmits energy or actuates a machine or heat engine. In this invention, working fluids may include: fuel in liquid or gaseous state, coolant 31, pressurized or other air that may or may not be heated. The fuel tank 22 is designed to include venting 64 from the component/mechanical compartment to the external temperature zone 54 and is installed with a design that provides for 50 ft drop without rupture of the fuel tank 22. The head side of the fuel tank 22 comprises multiple valves 88 and instruments for operation of the fuel tank 22. In one embodiment the head side of the fuel tank 22 comprises mating part A including an LH₂ refueling port (Female part of a fuel transfer coupling 58); mating part B including a ⅜″B (VENT 64), ¼″ (PT), ¼″ (PG&PC), feed through, vacuum port, vacuum gauge, spare port, ¼″ sensor (Liquid detection); and mating part C including at least one 1 inch union 86 (to interface with heat exchangers 57) as well as ½″ safety valves 88. Liquid hydrogen storage subsystems and fuel tanks 22 may employ at least one a fuel transfer coupling 58 for charging; 1 bar vent 64 for charging; self-pressure build up unit; at least two safety relief valves 88; GH₂ heating components; vessels and piping that routed to a heat exchanger 57 or are otherwise in contact with fluid conduits for fuel-cell coolant 31 water. The fuel tank 22 may also include a level sensor (High Capacitance) and meet regulatory requirements. Different example embodiments of the fuel tank 22 may include a carbon fiber epoxy shell or a stainless-steel shell material used to encapsulate the components of the fuel tank 22 to provide drop and crash protection. In another embodiment an LH₂ fuel tank 22 may comprise one or more inner tanks, an insulating wrap, a vacuum between inner and outer tank, and a much lower operating pressure, typically approximately 10 bar, or 140 psi (where GH₂ typically runs at a much higher pressure). The fuel tanks 22 may also be equipped with at least one protection ring to provide further drop and crash protection for connectors, regulators and similar components. In an example embodiment, the fuel supply subsystem 900 further comprises an LH₂ charging line used to fill the fuel tank 22 with liquid hydrogen (LH₂) to the stated amount and safely store it, where pressure sensors, pressure safety valves, pressure gauges, pressure regulators, and one or more pressure build units, monitor, regulate, and adjust the fuel tank 22 environment to maintain the fuel at the proper temperature and state to efficiently fuel the power generation subsystem 600 (with example fuel-cell modules 18) that is supplied using an LH₂ discharge line, wherein the fuel is adjusted by additional means comprising the one or more heat exchangers 57. To maintain continuity of delivery of fuel during displacement, as well as managing fuel safety, volatile gases may be passed through a vaporizer 72 and one or more GH₂ vent 64 connections to be vented to the exterior environment. Additional components include at least one vacuum sensor and port, and a level sensor feed through. the fuel supply subsystem 900 further comprises various components including, but not limited to, pressure transmitters, level sensors, coolant circulation pumps, and pressure regulators solenoid valves, used to monitor, direct, reroute, and adjust the flow of coolant through the coolant conduits in the proper manner to supply the power generation subsystem 600 (with example fuel-cell modules 18). In one embodiment, the fuel may be served by separate coolant (e.g. in fluid communication with heat exchangers 57) from the power generation subsystem 600 (with example fuel-cell modules 18), and in another embodiment, the fuel supply subsystem 900 shares a cooling loop or circuit comprising coolant conduits transporting coolant with the power generation subsystem 600 (with example fuel-cell modules 18), and in an additional embodiment, the fuel supply subsystem 900 may include fuel lines that serve as coolant conduits for various components including the power generation subsystem 600 (with example fuel-cell modules 18), either via thermal conductive contact or indirect contact by e.g. the one or more heat exchangers 57.

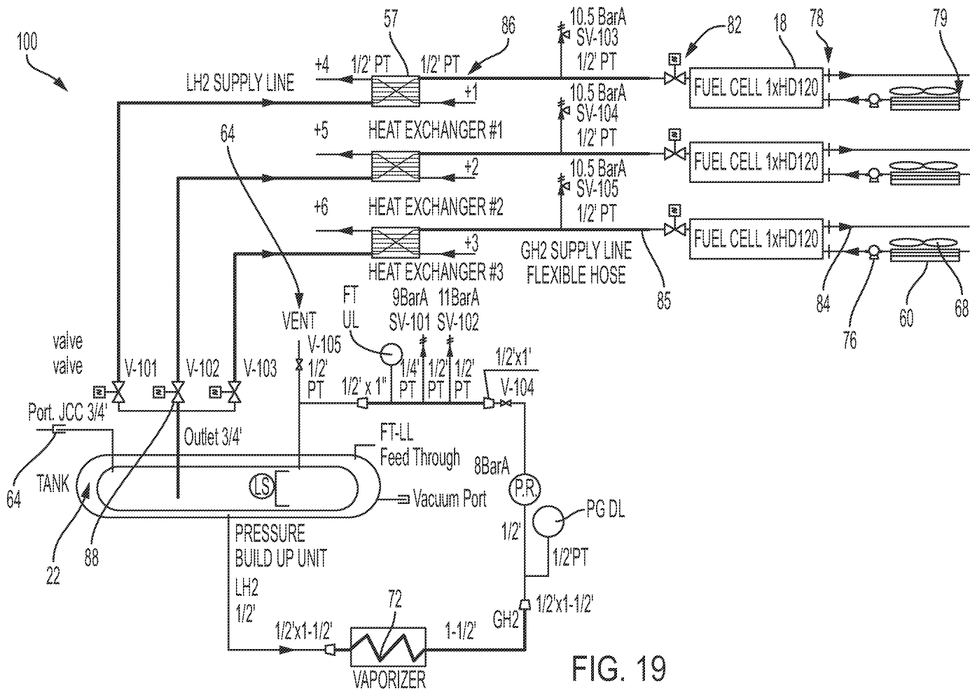

FIG. 19 depicts an example diagram of the fuel supply subsystem 900 including the fuel tank 22, fuel-cell, radiator 60, heat exchanger 57 and air conditioning components, along with the most basic components of the power generation subsystem 600. The integrated system 100 fuel supply subsystem 900 further comprises the fuel tank 22 in fluid communication with one or more fuel-cells, configured to store and transport a fuel selected from the group consisting of gaseous hydrogen (GH₂), liquid hydrogen (LH₂), or similar fluid fuels. The fuel supply subsystem 900 further comprises fuel lines, at least one fuel supply coupling, 58 refueling connections for charging, one or more vents 64, one or more valves 88, one or more pressure regulators, the vaporizer 72, unions 86 and the heat exchanger 57, each in fluid communication with the fuel tank 22, and wherein the one or more temperature sensing devices or thermal safety sensors monitor temperatures and concentrations of gases in the fuel supply subsystem 900, and also comprise one or more pressure gauges, one or more level sensors, one or more vacuum gauges, and one or more temperature sensors. The autopilot control unit 32 or a computer processor are further configured to operate components of the subsystems and compute, select and control, based on the temperature adjustment protocol, an amount and distribution of thermal energy transfer including: from the one or more sources comprising the power generation subsystem 600, to the one or more thermal energy destinations including: the internal temperature zone 52 (using HVAC subsystems 6), the external temperature zone 54 (using at least the at least one radiator 60 or the one or more exhaust ports 66), and the fuel supply subsystem 900 (using the thermal energy interface subsystem 56 comprising the heat exchangers 57 or a vaporizer 72). Distribution may occur from the one or more sources comprising the internal temperature zone 52, to the one or more thermal energy destinations comprising the fuel supply subsystem 900, using the HVAC subsystems; or from the external temperature zone 54, to the fuel supply subsystem 900, using one or more vents 64; and combinations thereof. FIG. 18 depicts the LH₂ 400 L fuel tank 22 together with pressure build up unit, LH₂ Alt Port, refueling port, pressure gauge w/ switch contact, pressure trans/level/vacuum gauge/pressure regulator, Vaporizer 72 for converting LH₂ to GH₂ and mating part A: LH₂ refueling port (female fuel transfer coupling 58); mating part B; ⅜″ B (Vent 64); mating part C 1″ union 86 (interface w/ heat exchanger 57). Also depicted are the at least one radiator 60, coolant outlet, example fuel-cell module 18, coolant inlet 78, air flow sensing and regulation, and coolant (cooling water circulation) pump 76. The thermal energy interface subsystem 56 depicted comprises the heat exchanger 57 or a vaporizer 72, configured to connect to a first fluid conduit in connection with and in fluid communication the fuel supply subsystem 900 comprising the fuel 30, and a second conduit in connection with and in fluid communication with the power generation subsystem 600 comprising the coolant 31, wherein thermal energy is transferred from the coolant 31, across a conducting interface by conduction, and to the fuel 30, thereby warming the fuel 30 and cooling the coolant 31, and wherein the one or more temperature sensing devices or thermal energy sensing devices further comprises a fuel temperature sensor and a coolant temperature sensor.

FIG. 19 demonstrates the interrelated conduits for heat transfer among components including fuel tank 22, fuel-cell, radiator 60, heat exchanger 57 and air conditioning components. In one embodiment, the cooling system comprises five (5) heat exchangers 57 configured for fuel-cell modules 18, motors, motor controllers 24, and electronics cooling by heat transfer. Heat exchangers 57 each comprise tubes, unions 86 (LH₂ Tank side), vacuum ports/feed through and vents 64. In various embodiments, one or more outlets from the inner vessel may be employed, and multiple inner vessels may be constructed inside the outer vessel. The vaporizer 72 may be interconnected by conduits 85, pipes 85 or tubes 85 to a heat exchanger 57, or may function as a heat exchanger 57 itself by contacting coolant conduits 84. In one embodiment, the heat exchangers 57 may further comprise lightweight aluminum heat exchangers 57 or compact fluid heat exchangers 57 that transfer energy/heat from one fluid to another more efficiently by implementing different principles related to thermal conductivity, thermodynamics and fluid dynamics. Such fluid heat exchangers 57 use the warm and/or hot fluid normally flowing inside a coolant conduit 84 and fuel lines 85. Heat energy is transferred by convection from the fluid (coolant 31) in the coolant conduit 84 as it flows through the system, wherein the moving fluid contacts the inner wall of the fluid conduit/coolant conduit 84 with a surface of a different temperature and the motion of molecules establishes a heat transfer per unit surface through convection. Then in thermal conduction heat spontaneously flows from a hotter fluid conduit/coolant conduit 84 to the cooler fuel flow tubes 85/fuel conduits 85/fuel lines 85 over the areas of physical contact between the two components within the heat exchanger 57 body. Heat energy is then transferred by convection again from the inner wall of the inflow tubes 85/fuel conduits 85/fuel lines 85 to fluid in the fuel line 85 flowing by contacting the surface area of the inner wall of the fuel flow tubes 85/fuel conduits 85/fuel lines 85. Heat exchangers 57 may be of standard flow classifications including: parallel-flow; counter-flow; and cross-flow. Heat exchangers 57 may be shell and tube, plate, fin, spiral and combinations of said types. The heat exchanger 57 body, tubes, pipes, lines and conduits may be comprised of one of copper, stainless steel, and alloys and combinations thereof, or other conductive material. The first open end a fluid heat exchanger 57 may be connected to, and in fluid communication with, a coolant conduit 84. The second open end is connected to, and in fluid communication with, a second coolant conduit 84 that transports fluids (coolant 31) to other subsystems including the power generation subsystem 600 (e.g. fuel-cell modules 18), the external temperature zone 54, and in particular, the radiator 60. The third open end of the fluid heat exchanger 57 may be connected to, and in fluid communication with, inflow tubes 85/fuel conduits 85/fuel lines 85. The fourth open end of the fluid heat exchanger 57, is connected to, and in fluid communication with, inflow tubes 85/fuel conduits 85/fuel lines 85, such that the fluid heat exchanger 57 may replace a section of fluid conduits, coolant conduits 84, pipes, fuel lines 85 flowing into or out of the fuel supply subsystem 900, power generation subsystem 600, internal temperature zone 52, or external temperature zone 54, recapturing heat from fluids flowing through the exchanger 57 and transferring that heat to incoming fluids. Connection may be made using any known method of connecting pipes. The measuring of thermodynamic operating conditions comprises measuring a first temperature corresponding to one or more sources of thermal energy and assessing one or more additional temperatures corresponding to thermal references, and wherein the one or more thermal references comprise one or more references selected from the group consisting of operating parameters, warning parameters, equipment settings, occupant control settings, alternative components, alternative zones, temperature sensors, and external reference information. The one or more sources are selected from the group consisting of the power generation subsystem 600, the internal temperature zone 52, the external temperature zone 54, and the fuel supply subsystem 900. The one or more thermal energy destinations are selected from the group consisting of the power generation subsystem 600, the internal temperature zone 52, the external temperature zone 54, and the fuel supply subsystem 900. In one embodiment, the fuel-cell control system 100 comprises 6 motors and 3 fuel-cell modules 18; 1 fuel-cell for each 2-motor pair. The fuel-cell modules 18 are triple-modular redundant auto-pilot with monitor, Level A analysis of source code, and at least one cross-over switch in case of one fuel-cell failure. In some embodiments, fuel tank 22, the avionics battery 27, the fuel pump 74 and cooling system 44, supercharger 46, and radiators 60 may also be included, monitored, and controlled. Any fuel-cell modules 18 are fed by on-board fuel tank 22 and use the fuel 30 to produce a source of power for the multirotor aircraft 1000. These components are configured and integrated to work together with 4D Flight Management. Power generation subsystem 600 may have various numbers of fuel-cells based on the particular use configuration, for example a set of hydrogen fuel-cells. Operation and control of the cells is enabled via CAN protocol or a similar databus or network or wireless or other communications means. Flight control algorithm will modulate and monitor the power delivered by fuel-cells via CAN.

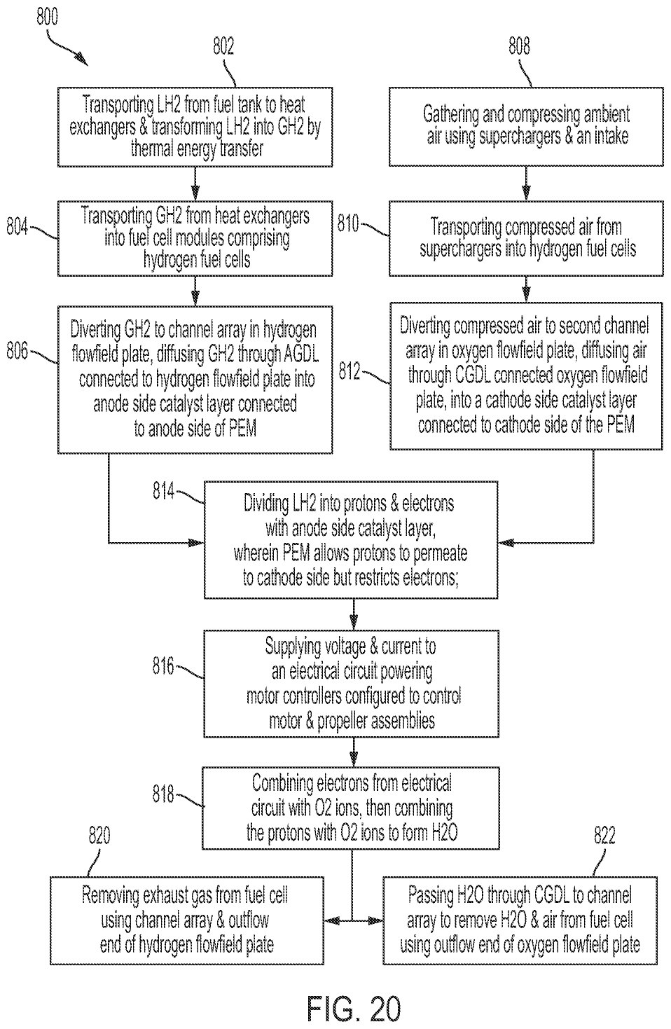

FIG. 20 depicts a flow chart that illustrates an example fuel-cell process subject to health assessment by the present invention in accordance with one example embodiment. The method 800 comprises: at Step 802 transporting liquid hydrogen (LH₂) fuel from a fuel tank 22 to one or more heat exchangers 57 in fluid communication with the fuel tank 22, and transforming the state of the LH₂ into gaseous hydrogen (GH₂) using the one or more heat exchangers 57 to perform thermal energy transfer to the LH₂; and Step 804 transporting the GH₂ from the one or more heat exchangers 57 into one or more fuel-cell modules 18 comprising a plurality of hydrogen fuel-cells in fluid communication with the one or more heat exchangers 57. The method steps further comprise at Step 806 diverting the GH₂ inside the plurality of hydrogen fuel-cells into a first channel array embedded in an inflow end of a hydrogen flowfield plate 18d in each of the plurality of hydrogen fuel-cells, forcing the GH₂ through the first channel array, diffusing the GH₂ through an anode backing layer comprising an anode Gas diffusion layer (AGDL) 18b in surface area contact with, and connected to, the first channel array of the hydrogen flowfield plate 18d, into an anode side catalyst layer connected to the AGDL and an anode side of a proton exchange membrane (PEM 18c) of a membrane electrolyte assembly (MEA) 18c. At Step 808 the system 100 performs gathering and compressing ambient air into compressed air using one or more turbochargers or superchargers 46 in fluid communication with an intake. The system 100 performs, at Step 810 transporting compressed air from the one or more turbochargers or superchargers 46 into the one or more fuel-cell modules 18 comprising the plurality of hydrogen fuel-cells in fluid communication with the one or more turbochargers or superchargers 46; and at Step 812 diverting compressed air inside the plurality of hydrogen fuel-cells into a second channel array embedded in an inflow end of an oxygen flowfield plate 18d in each of the plurality of hydrogen fuel-cells disposed opposite the hydrogen flowfield plate 18d, forcing the GH₂ through the second channel array, diffusing the compressed air through a cathode backing layer comprising a cathode gas diffusion layer (CGDL) 18b in surface area contact with, and connected to, the second channel array of the oxygen flowfield plate 18d, into a cathode side catalyst layer connected to the CGDL and a cathode side of the PEM 18c of the membrane electrolyte assembly. At Step 814 dividing the LH₂ into protons or hydrogen ions of positive charge and electrons of negative charge through contact with the anode side catalyst layer, wherein the PEM 18c allows protons to permeate from the anode side to the cathode side through charge attraction but restricts other particles comprising the electrons; at Step 816 supplying voltage and current to an electrical circuit powering a power generation subsystem comprising a plurality of motor controllers 24 configured to control a plurality of motor and propeller assemblies 28 in the multirotor aircraft; at Step 818 combining electrons returning from the electrical current of the electrical circuit with oxygen in the compressed air to form oxygen ions, then combining the protons with oxygen ions to form H₂O molecules; at Step 820 passing the H₂O molecules through the CGDL into the second channel array to remove the H₂O and the compressed air from the fuel-cell using the second channel array and an outflow end of the oxygen flowfield plate 18d; and at Step 822 removing exhaust gas from the fuel-cell using the first channel array and an outflow end of the hydrogen flowfield plate 18d. Excess heat generated by the function of the fuel-cells can be expelled with exhaust gas and/or H₂O, dissipated through use of one or more coolant filled radiators, or supplied by a working fluid in fluid conduits used by one or more heat exchangers 57 to extract GH₂ from LH₂ through thermal energy transfer that heats the LH₂ without direct interface between the two different fluids. In one example embodiment, GH₂ and oxygen molecules or air from the compressed air may pass through the fuel-cells and fuel-cell modules 18 and out a hydrogen outlet and oxygen outlet respectively, wherein each may be configured to be in fluid communication with additional fluid conduits recycling the fluids and directing the GH₂ and oxygen or air back into the fuel supply subsystem and external interface subsystem to be reused in subsequent reactions performed within the fuel-cells and fuel-cell modules 18 as the process steps of the invention are performed iteratively to produce electricity, heat and H₂O vapor on an ongoing basis.

The executing thermal energy transfer from the power generation subsystem 600 to the one or more thermal energy destinations, using the autopilot control units 32 or computer processors, may comprise using a fluid in fluid communication with a component of the power generation subsystem 600 to transport heat or thermal energy to a different location corresponding to a thermal energy destination, thereby reducing the temperature or excess thermal energy of the one or more sources. To accomplish this the processor selects a source and thermal energy destination pair, and retrieves stored routing data for the pair, then activates, actuates, or adjusts the appropriate valves 88, regulators, conduits, and components to send a working fluid through the aircraft 1000 directing the flow of fluid from the source to the one or more thermal energy destinations. For example, if the temperature adjustment protocol indicates a fuel-cell module 18 requires dissipation and transfer of waste heat, the processor may select the fuel supply subsystem 900 as a thermal energy destination, and the processor will actuate the coolant pump 76 and appropriate valves 88 in fluid communication with the coolant conduits 84 connected to and in fluid communication with that fuel-cell module 18, so that coolant 31 is moved from the fuel-cell module 18, through the coolant conduits 84 and piping 84 along a route that leads to a heat exchanger 57, and in turn similarly actuates pumps and valves 88 in the fuel lines 85, such that coolant 31 and fuel 30 flow through separate conduits of the processor activated heat exchanger 57 simultaneously and heat or thermal energy is transferred from the hotter coolant 31, across the conduits, walls and body of the heat exchanger 57, and into the colder fuel 30, thereby reducing the temperature of the fuel-cell module 18 source and increasing the temperature of the fuel 30, or more generally the fuel supply subsystem 900. The executing thermal energy transfer from the one or more sources to the one or more thermal energy destinations may further comprise diverting fluid flow of the fuel 30 or the coolant 31 using valves 88 and coolant pumps 76, wherein the coolant 31 may comprise water and additives (such as anti-freeze). As the processors continue to measure the fuel-cell module 18, processors may divert flow to other thermal energy destinations or reduce flow to the heat exchanger 57 or stop flow to the heat exchanger 57 and redirect the flow to a different thermal energy destination. Multiple processors may work together to perform different functions to accomplish energy transfer tasks. The integrated system 100 iteratively or continuously measures the components, zones and subsystems to constantly adjust energy transfer and temperature performance of the aircraft 1000 to meet design and operating condition parameters. Measuring, using one or more temperature sensing devices or thermal energy sensing devices, thermodynamic operating conditions in a multirotor aircraft 1000 comprising a first temperature corresponding to a source of thermal energy and one or more additional temperatures corresponding to thermal references further comprise measuring one or more selected from the group consisting of a fuel temperature, a fuel tank temperature, fuel-cell or fuel-cell module 18 temperatures, battery temperatures, motor controller temperatures, a coolant temperature or peak controller temperature, motor temperatures, or peak motor temperature or aggregated motor temperature, radiator 60 temperatures, a cabin temperature, and an outside-air temperature. The temperature adjustment protocols may be computed by the example method 700 and integrated system 100 using autopilot control units 32 or computer processor and an algorithm based on the comparison result. The selecting and controlling, based on the temperature adjustment protocol, of an amount and distribution of thermal energy transfer from the one or more sources further comprises ordering the one or more thermal energy destinations, selecting and controlling, based on the temperature adjustment protocol, an amount and distribution of thermal energy transfer from the one or more sources further comprises. The processor interrogates the system to determine the answer to a series of questions that determine subsequent calculations, computations, priorities, protocols, and allocations. For example, is power generation subsystem 600 hotter than interface set temperature? Is power generation subsystem 600 hotter than interface max temperature? Is power generation subsystem 600 hotter than external temperature zone 54? For example, if the temperature difference between the power generation subsystem 600 and the fuel supply subsystem 900 remains large, then transfer from the power generation subsystem 600 source to the fuel supply subsystem 900 thermal energy destination will be enacted. The external temperature zone 54 may further comprise an external temperature outlet, comprising an exhaust port 66 or a vent 64 that may be linked to one or more radiators 60 and one or more fans 68. A processor may set the exterior temperature zone as a thermal energy destination for a fuel-cell module 18 source, but if the radiator 60 or coolant temperature begins to exceed normal or safe operating limit temperatures, the processor may then readjust the temperature distribution protocol and priorities, actuating additional coolant 31 flow to a heat exchanger 57 to add the fuel supply subsystem 900 as an additional thermal energy destination, thereby reducing the cooling load required of the radiator 60 and further reducing the temperature of the fuel-cell module 18 source to bring that source to an improved operating temperature. The thermal interface of the thermal energy/temperature exchange subsystem is important for interconnecting multiple subsystems and components located far apart on the aircraft 1000 and facilitating the use of working fluids to transport heat and thermal energy for transfer to various destinations. The thermal interface further comprises one or more heat exchangers 57 configured to transfer heat or thermal energy from the coolant 31 supplied by coolant conduits 84 in fluid communication with the one or more heat exchangers 57, across heat exchanger 57 walls and heat exchanger 57 surfaces, to the fuel 30 supplied by fuel lines 85 in fluid communication with the one or more heat exchangers 57, using thermodynamics including conduction, wherein the coolant 31 and the fuel 30 remain physically isolated from one another. As the process steps of the invention are performed iteratively to produce electricity, heat or thermal energy (including heated fluid coolant 118) and H₂O vapor are generated and transferred on an ongoing basis.

In alternative embodiments, controlling the system comprises executing of a thermal energy transfer from the power generation subsystem to one or more thermal energy destinations, using the autopilot control units or computer processors, may comprise using a fluid in fluid communication with a component of the power generation subsystem to transport heat or thermal energy to a different location corresponding to a thermal energy destination, thereby reducing the temperature or excess thermal energy of the one or more sources. To accomplish this the processor selects a source and thermal energy destination pair, and retrieves stored routing data for the pair, then activates, actuates, or adjusts the appropriate valves, regulators, conduits, and components to send a working fluid, including the fluid coolant 118, through the aircraft 1000 directing the flow of fluid from the source to the one or more thermal energy destinations. For example, if the temperature adjustment protocol indicates a fuel-cell module receiving heated fluid from a motor 126 and cooling body 102 requires dissipation and transfer of waste heat, the processor may select the fuel supply subsystem as a thermal energy destination, and the processor will actuate the coolant pump and appropriate valves in fluid communication with the fluid coolant conduits 142 connected to and in fluid communication with that fuel-cell module, so that fluid coolant 118 is moved from the fuel-cell module, through the fluid coolant conduits 142 and piping along a route that leads to a heat exchanger, and in turn similarly actuates pumps and valves 88 in the fuel lines 85, such that coolant 31 and fuel 30 flow through separate conduits of the processor activated heat exchanger 57 simultaneously and heat or thermal energy is transferred from the hotter coolant 31, across the conduits, walls and body of the heat exchanger 57, and into the colder fuel 30, thereby reducing the temperature of the fuel-cell module 18 source and increasing the temperature of the fuel 30, or more generally the fuel supply subsystem. The executing thermal energy transfer from the one or more sources to the one or more thermal energy destinations may further comprise diverting fluid flow of the fuel 30 or the coolant 31 using valves 88 and coolant pumps 76, wherein the coolant 31 may comprise water and additives (such as anti-freeze). As the processors continue to measure the fuel-cell module 18, processors may divert flow to other thermal energy destinations or reduce flow to the heat exchanger or stop flow to the heat exchanger and redirect the flow to a different thermal energy destination.

In each example embodiment, multiple processors may work together to perform different functions to accomplish energy transfer tasks. The integrated system iteratively or continuously measures the components, zones and subsystems to constantly adjust energy transfer and temperature performance of the aircraft 1000 to meet design and operating condition parameters. Measuring, using one or more temperature sensing devices or thermal energy sensing devices, thermodynamic operating conditions in a multirotor aircraft 1000 comprising a first temperature corresponding to a source of thermal energy and one or more additional temperatures corresponding to thermal references further comprise measuring one or more selected from the group consisting of a fuel temperature, a fuel tank temperature, fuel-cell or fuel-cell module temperatures, battery temperatures, motor controller temperatures, a coolant temperature or peak controller temperature, motor temperatures, or peak motor temperature or aggregated motor temperature, radiator 60 temperatures, a cabin temperature, and an outside-air temperature. The temperature adjustment protocols may be computed by the example method 700 and integrated system using autopilot control units 32 or computer processor and an algorithm based on the comparison result. The selecting and controlling, based on the temperature adjustment protocol, of an amount and distribution of thermal energy transfer from the one or more sources further comprises ordering the one or more thermal energy destinations, selecting and controlling, based on the temperature adjustment protocol, an amount and distribution of thermal energy transfer from the one or more sources further comprises. to bring that source to an improved operating temperature. After executing thermal energy transfer from the one or more sources to the one or more thermal energy destinations, the example method repeats measuring, using one or more temperature sensing devices or thermal energy sensing devices, thermodynamic operating conditions in a multirotor aircraft 1000 comprising power generation, fuel supply and related subsystems, and then performs comparing, computing, selecting and controlling, and executing steps data for the one or more fuel-cells and the one or more motor control units to iteratively manage operating conditions in the multirotor aircraft 1000.

The methods 200, 800 and systems 100 described herein are not limited to a particular aircraft 1000 or hardware or software configuration and may find applicability in many aircraft or operating environments. For example, the algorithms described herein can be implemented in hardware, software, or a combination thereof. The methods 200, 700 and systems 100 can be implemented in one or more computer programs, where a computer program can be understood to include one or more processor executable instructions. The computer program(s) can execute on one or more programmable processors and can be stored on one or more storage medium readable by the processor (including volatile and non-volatile memory and/or storage elements), one or more input devices, and/or one or more output devices. The processor thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, USB Flash storage, or other storage device capable of being accessed by a processor as provided herein, a mission control tablet computer 36, mission planning software 34 program, throttle pedal, sidearm controller, yoke or control wheel, or other motion-indicating device capable of being accessed by a processor, where such aforementioned examples are not exhaustive, and are for illustration and not limitation.

The computer program(s) is preferably implemented using one or more high level procedural or object-oriented programming languages to communicate with a computer system; however, the program(s) can be implemented in assembly or machine language, if desired. The language can be compiled or interpreted.

As provided herein, the processor(s) can thus in some embodiments be embedded in three identical devices that can be operated independently or together in a networked or communicating environment, where the network can include, for example, a Local Area Network (LAN) such as Ethernet, wide area network (WAN), serial networks such as RS232 or CAN and/or can include an intranet and/or the internet and/or another network. The network(s) can be wired, wireless RF, or broadband, or a combination thereof and can use one or more communications protocols to facilitate communications between the different processors. The processors can be configured for distributed processing and can utilize, in some embodiments, a client-server model as needed. Accordingly, the methods and systems can utilize multiple processors and/or processor devices to perform the necessary algorithms and determine the appropriate vehicle commands, and if implemented in three units, the three units can vote among themselves to arrive at a 2 out of 3 consensus for the actions to be taken. As would be appreciated by one skilled in the art, the voting can also be carried out using another number of units (e.g., one two, three, four, five, six, etc., the processor instructions can be divided amongst such single or multiple processor/devices). For example, the voting can use other system-state information to break any ties that may occur when an even number of units disagree, thus having the system arrive at a consensus that provides an acceptable level of safety for operations.

The device(s) or computer systems that integrate with the processor(s) for displaying presentations can include, for example, a personal computer with display, a workstation (e.g., Sun, HP), a personal digital assistant (PDA) handheld device such as cellular telephone, laptop, handheld, or tablet such as an iPad, or another device capable of communicating with a processor(s) or being integrated with a processor(s) that can operate as provided herein. Accordingly, the devices provided herein are not exhaustive and are provided for illustration and not limitation.

References to “a processor” or “the processor” can be understood to include one or more processors that can communicate in a stand-alone and/or a distributed environment(s), and thus can be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network using a variety of communications protocols, and unless otherwise specified, can be arranged to include a combination of external and internal memory devices, where such memory can be contiguous and/or partitioned based on the application. References to a database can be understood to include one or more memory associations, where such references can include commercially available database products (e.g., SQL, Informix, Oracle) and also proprietary databases, and may also include other structures for associating memory such as links, queues, graphs, trees, with such structures provided for illustration and not limitation. References to a network, unless provided otherwise, can include one or more networks, intranets and/or the internet.

Although the methods and systems have been described relative to specific embodiments thereof, they are not so limited. For example, the methods and systems may be applied to a variety of vehicles having 6, 8, 10, 12, 14, 16, or more independent motor controllers and motors 126, thus providing differing operational capabilities. For example, the methods and systems may be applied to monitoring fuel-cell and motor performance in the trucking industry, or other industries where trend monitoring may help reduce fuel-cell maintenance and/or overhaul requirements. The system may be operated under an operator's control, or it may be operated via network or datalink from the ground. As described with respect to FIGS. 2 and 3 for aircraft fuel-cell monitoring, a driver, marine pilot, or other operator may operate an fuel-cell at steady state or “cruise” conditions to obtain fuel-cell parameter readings for historical analysis. Such systems will find utility in cargo and passenger-carrying operations, particularly with regard to US Part 135 regulations and foreign equivalents, but are also intended to enhance overall operation safety for any operator of fuel-cell and electric motor vehicles. Many modifications and variations may become apparent in light of the above teachings and many additional changes in the details, materials, and arrangement of parts, herein described and illustrated, may be made by those skilled in the art.

What is claimed is:

1. A method of producing a health assessment of a fuel-cell and motor system powering an aircraft, the method comprising:
obtaining current fuel-cell and motor performance data from the fuel-cell and motor system reported by one or more onboard sensors during flight operation;
obtaining current aircraft performance data from the aircraft reported by a plurality of onboard aircraft sensors and data stores during flight operation;
comparing the current aircraft performance data with prior aircraft performance data to identify quantitative ranges of operation where the current aircraft performance data overlaps with the prior aircraft performance data within a predetermined range of acceptable difference to identify a quantitative range of similar aircraft performance;
matching the quantitative range of similar aircraft performance with a similar range corresponding to prior fuel-cell and motor performance data to identify a subset of prior fuel-cell and motor performance data;
comparing the current fuel-cell and motor performance data with the subset of prior fuel-cell and motor performance data and identifying differences in fuel-cell and motor performance data for a given range of aircraft performance;
transforming the differences in fuel-cell and motor performance data to one or more health indicators using a processor and one or more algorithms; and
outputting the health indicators to a user interface in the form of the health assessment.

2. The method of claim 1, wherein the health assessment comprises one or more of: a graph, message, text warning, and indicator.

3. The method of claim 1, wherein the health assessment is used in a trend analysis.

4. The method of claim 1, wherein the method is implemented using only systems and processors onboard the aircraft.

5. The method of claim 1, wherein the method is implemented by further comprising transmitting the subset of prior fuel-cell and motor performance data to a location not onboard the aircraft and performing subsequent steps of comparing the current fuel-cell and motor performance data, transforming the differences in fuel-cell and motor performance data, and outputting the health indicators at a location not onboard the aircraft.

6. The method of claim 1, wherein the display device comprises a primary flight display or avionics display with an arrangement of standard avionics used to monitor and display one or more of operating conditions, control panels, gauges instrument output and sensor output for a clean fuel aircraft.

7. The method of claim 1, wherein obtaining current fuel-cell and motor-performance data using one or more onboard sensors comprises obtaining at least one instrument output or sensor output taken from a listing of outputs measuring one or more of hydrogen temperature, oxygen temperature, fuel temperature, fuel tank temperature, fuel-cell output voltage and current, hydrogen fuel flow, humidity, motor temperature, motor controller temperatures, stack temperatures, coolant temperature, radiator temperature, heat exchanger temperature, battery temperature, hydrogen pressure, oxygen or air pressure, propeller speed (RPM), or outputs of fuel-cell-internal-condition sensors.

8. The method of claim 1, wherein obtaining current aircraft performance data comprises obtaining at least one instrument output or sensor output taken from a listing of outputs measuring one or more of true airspeed, indicated airspeed, pressure altitude, density altitude, outside air temperature, and vertical speed.

9. The method of claim 1, wherein obtaining current fuel-cell and motor performance data comprises periodically obtaining and recording at least one instrument output or sensor output at environmental conditions gathered from the current aircraft performance data wherein the at least one instrument output or sensor output comprises an output from one or more of an altimeter, an airspeed indicator, a vertical speed indicator, a magnetic compass, an attitude Indicator, an artificial horizon, a heading indicator, a directional gyro, a slip or skid horizontal situation indicator (HSI), a turn indicator, a turn-and-slip indicator, a turn coordinator, an indicator of rotation about a longitudinal axis, an inclinometer, an attitude director indicator (ADI) with computer-driven steering bars, a navigation signal indicator, a glide slope indicator, a very-high frequency omnidirectional range (VOR) course deviation indicator (CDI)/localizer, a GPS, an omnibearing selector (OBS), a TO/FROM indicator, a nondirectional radio beacon (NDB) instrument, flags instruments, an automatic direction finder (ADF) indicator instrument, a radio magnetic indicator (RMI), a gyrocompass, instruments representing aircraft heading, a glass cockpit instruments primary flight display (PFD), a temperature sensing device, a thermal safety sensor, a pressure gauge, a level sensor, a vacuum gauge, operating conditions sensors in a clean fuel aircraft, or combinations thereof.

10. The method of claim 1, wherein obtaining current fuel-cell and motor performance data further comprises determining, from fuel-cell and motor performance data, if the fuel-cell and motor system is operating within a predetermined parameter set or exceeds predefined fuel-cell and motor system operating conditions by:
deriving performance data values from the performance data;
accessing the predetermined parameter set previously stored; and
analyzing whether comparison to corresponding predetermined parameter set values indicates deviation larger than a threshold stored in the predetermined parameter set.

11. The method of claim 1, wherein comparing the current aircraft performance data with prior aircraft performance data comprises determining if trend records for a predetermined number of previous uses are stored.

12. The method of claim 11, wherein the comparing the current aircraft performance data with prior aircraft performance data comprises obtaining averages for values stored in the trend records for previous uses and comparing values of a current trend record to corresponding averages from the trend records for the predetermined number of previous uses.

13. The method of claim 12, wherein obtaining averages comprises obtaining averages for chronological groupings of trend records for previous uses.

14. The method of claim 13, wherein the comparing the current fuel-cell and motor performance data with the subset of prior fuel-cell and motor performance data comprises:
obtaining a predicted value for at least one instrument output or sensor output;
storing a difference between the predicted value and an actual value of the at least one instrument output or sensor output to a current trend record; and
storing other instrument outputs or sensor outputs to a current trend record.

15. The method of claim 14, wherein the comparing the current fuel-cell and motor performance data with the subset of prior fuel-cell and motor performance data comprises:
obtaining predicted values for the fuel-cell and motor system performance data; and
storing differences between the predicted values and actual values of the fuel-cell and motor system performance data to a current trend record.

16. The method of claim 15, wherein outputting of health indicators further comprises:
displaying values of a current trend record;
displaying corresponding averages; and
displaying tolerances or thresholds associated with respective values of the current trend record.

17. The method of claim 16, wherein displaying comprises displaying values associated with instrument outputs or sensor outputs using a Controller Area Network (CAN) bus, taken from a listing of outputs including motorspeed, fluid pressure, hydrogen fuel flow, air speed, altitude, cell temperature, cell pressure, maximum stack temperature, minimum stack temperature, maximum exhaust fluid temperature, temperature of a first cell of the stack up through and including the temperature of a last cell in the stack, wherein one or more fuel-cell modules and one or more motor controllers are each configured to self-measure and report temperature and other parameters.

18. The method of claim 1, wherein obtaining current fuel-cell and motor performance data comprises providing an indication to an operator when a value of at least one of one or more onboard sensors differs from a predicted value by more than a predetermined tolerance or threshold.

19. The method of claim 18, further comprising obtaining the predicted value from a database or a lookup table that is computer-based.

20. The method of claim 19, further comprising performing, using one or more autopilot control units or processors, interpolation calculations within the database or the lookup table.

21. The method of claim 20, further comprising performing, using the one or more autopilot control units or processors, interpolation calculations within the lookup table, using machine learning or regression analysis to perform interpolation.

22. The method of claim 21, wherein the outputting further comprises displaying a historical record corresponding to a periodically obtained at least one instrument output or sensor output.

23. The method of claim 1, wherein the fuel-cell and motor system is a hydrogen fuel-cell system.

24. The method of claim 23, wherein the fuel-cell system is an aircraft fuel-cell system.

25. The method of claim 24, further comprising controlling the fuel-cell and motor system to operate within a predetermined parameter set.

26. The method of claim 25, wherein controlling the fuel-cell and motor system to operate within a predetermined parameter set comprises:
one or more autopilot control units operating control algorithms generating commands to each of the plurality of fuel-cells and each of the plurality of motor controllers, and fuel supply subsystem;
managing and maintaining multirotor aircraft stability for the clean fuel aircraft and monitoring feedback;
maintaining a certain altitude to allow the fuel-cell and motor system to stabilize;
setting the fuel-cell system at a recommended percent cruise voltage and current, and RPM, setting corresponding oxygen fuel supply and hydrogen fuel supply to each of the plurality of fuel-cells based on the performance data for each of the plurality of fuel-cells;
setting a recommended best performance voltage and current, and corresponding oxygen supply and hydrogen supply to each of the plurality of fuel-cells; and
setting a recommended best economy voltage and current and motor RPM, and corresponding oxygen supply and hydrogen supply to each of the plurality of fuel-cells and motors.

27. The method of claim 25, wherein controlling the fuel-cell and motor system to operate within a predetermined parameter set comprises:
measuring, using one or more sensors, operating conditions in a multirotor aircraft, and then performing comparing, computing, selecting and executing steps using the performance data for one or more fuel-cell and motor modules to iteratively manage electric voltage and current or torque production and supply by the one or more fuel-cell and motor modules and operating conditions in the multirotor aircraft;
wherein at least one instrument or sensor report performance data using a controller area network (CAN) bus to inform the autopilot control units or processors for computer units as to a particular valve, pump, vent, transducer or combination thereof to enable to increase or decrease fuel supply or cooling using fluids, wherein the one or more autopilot control units comprise at least two redundant autopilot control units that command a plurality of motor controllers, a fuel supply subsystem, the one or more fuel-cell modules, and fluid control units with commands operating valves, pumps, vents and transducers altering flows of fuel, air and coolant to different locations, and wherein the at least two redundant autopilot control units communicate the voting process over a redundant network; and
wherein the method repeats in an iterative process at set intervals, establishing stable cruise conditions, then recording performance data at the stable cruise conditions and plotting trend lines to display key performance indicators results.

28. The method of claim 27, wherein the recommended best performance voltage and current, and the recommended best economy voltage and current, are set using the current fuel-cell and motor performance data, prior fuel-cell and motor performance data, the predetermined parameter set, and indicators of how efficient the plurality of fuel-cells and motors are operating during a current flight compared against prior flights at designated matching performance parameters and operating conditions, comprising one or more of payload on-board, forward cruise speed, vertical speed, air temperature, air density or pressure, altitude, fuel-cell module current, fuel-cell module voltage, total current, total voltage, motor torque, total power, coolant temperature, hydrogen flow rate and fuel pressure.

29. The method of claim 28, wherein obtaining current aircraft performance data accessing data from a third set of a plurality of onboard sensors of the aircraft that are linked in a network and gathering sensor outputs from the network that are then aggregated and processed by an onboard processor or a remote processor to generate a model of the aircraft represented using a primary flight display or avionics display graphical user interface that maintains proportional relationships between graphical representations of sensor elements and other aircraft elements that accurately reflect actual distances and configurations of onboard sensors and aircraft elements.

30. A system for monitoring performance of a fuel-cell and motor system, comprising:
one or more onboard sensors reporting fuel-cell and motor performance during flight operation;
a plurality of onboard aircraft sensors and data stores reporting current aircraft performance data during flight operation;
one or more autopilot control units or processors for computer units performing steps comprising:
comparing the current aircraft performance data with prior aircraft performance data to identify ranges of operation where the current aircraft performance data overlaps with the prior aircraft performance data within a predetermined range of acceptable difference to identify a time segment of similar aircraft performance;
matching the range of similar aircraft performance with a same similar range corresponding to prior fuel-cell and motor performance data to identify a subset of prior fuel-cell and motor performance data;
comparing the current fuel-cell and motor performance data with the subset of prior fuel-cell and motor performance data and identifying differences in fuel-cell and motor performance data; and
transforming the differences in fuel-cell and motor performance data to one or more health indicators using a processor and one or more algorithms; and
a display outputting the health indicators to a user interface in the form of a health assessment.

31. The system of claim 30, wherein the fuel-cell system comprises at least one fuel-cell module comprising:
a plurality of hydrogen fuel-cells in at least one stack, configured to supply electrical voltage and current to a plurality of motor and propeller assemblies controlled by a plurality of motor controllers, and in fluid communication with one or more heat exchangers and one or more turbochargers or superchargers, each hydrogen fuel-cell of the plurality of hydrogen fuel-cells comprising:
a hydrogen flowfield plate, disposed in each hydrogen fuel-cell, and comprising a first channel array configured to divert gaseous hydrogen (GH₂) inside each hydrogen fuel-cell through an anode backing layer connected thereto and comprising an anode gas diffusion layer (AGDL) connected to an anode side catalyst layer that is further connected to an anode side of a proton exchange membrane (PEM), the anode side catalyst layer configured to contact the GH₂ and divide the GH₂ into protons and electrons;
an oxygen flowfield plate, disposed in each hydrogen fuel-cell, and comprising a second channel array configured to divert compressed air inside each hydrogen fuel-cell through a cathode backing layer connected thereto and comprising a cathode gas diffusion layer (CGDL) connected to a cathode side catalyst layer that is further connected to a cathode side of the PEM, wherein the PEM comprises a polymer and is configured to allow protons to permeate from the anode side to the cathode side but restricts the electrons;
an electrical circuit configured to collect electrons from the anode side catalyst layer from each hydrogen fuel-cell of the plurality of hydrogen fuel-cells and supply voltage and current to the plurality of motor controllers and aircraft components, wherein electrons returning from the electrical circuit combine with oxygen in the compressed air to form oxygen ions, then the protons combine with oxygen ions to form H₂O molecules; wherein the plurality of motor controllers are commanded by the one or more autopilot control units or processors of computer units, comprising a computer processor configured to compute algorithms based on measured operating conditions, and configured to select and control an amount and distribution of electrical voltage and torque or current for each of the plurality of motor and propeller assemblies;
an outflow end of the oxygen flowfield plate configured to use the second channel array to remove the H₂O and the compressed air from each hydrogen fuel-cell; and
an outflow end of the hydrogen flowfield plate configured to use the first channel array to remove exhaust gas from each hydrogen fuel-cell;
wherein the at least one fuel-cell module further comprises a module housing, a fuel delivery assembly, air filters, blowers, airflow meters, a recirculation pump, a coolant pump, fuel-cell controls, sensors, an end plate, coolant conduits, connections, a hydrogen inlet, a coolant inlet, an oxygen inlet, a hydrogen outlet, air and/or oxygen outlets, a coolant outlet, and coolant conduits connected to and in fluid communication with the at least one fuel-cell module and transporting coolant.

32. The system of claim 31, wherein the fuel-cell system further comprises:
a fuel supply subsystem comprising a fuel tank in fluid communication with the at least one fuel-cell module, fuel lines, fuel pumps, refueling connections for charging or fuel connectors, one or more vents, one or more valves, one or more pressure regulators, and unions, each in fluid communication with the fuel tank that is configured to store and transport a fuel comprising gaseous hydrogen (GH₂) or liquid hydrogen (LH₂);
a thermal energy interface subsystem comprising a heat exchanger in fluid communication with the fuel tank and the at least one fuel-cell module including each hydrogen fuel-cell of the plurality of hydrogen fuel-cells, a plurality of fluid conduits, and at least one radiator in fluid communication with the at least one fuel-cell module, configured to store and transport a coolant; and
a power distribution monitoring and control subsystem for monitoring and controlling distribution of supplied electrical voltage and current from the plurality of hydrogen fuel-cells to the plurality of motor controllers that are high-voltage, high-current liquid-cooled or air-cooled motor controllers, comprising:
one or more sensors configured to measure operating conditions and output performance data or environmental data, wherein one or more sensors monitor temperatures and concentrations of gases in the fuel supply subsystem, and also comprise one or more pressure gauges, one or more level sensors, one or more vacuum gauges, one or more temperature sensors;
wherein the one or more autopilot control units or processors of computer units comprise:
a computer processor and input/output interfaces comprising at least one of interface selected from serial RS232, controller area network (CAN), Ethernet, analog voltage inputs, analog voltage outputs, pulse-width-modulated outputs for motor control, an embedded or stand-alone air data computer, an embedded or stand-alone inertial measurement device, and one or more cross-communication channels or networks, a mission planning computer comprising software, with wired or wireless (RF) connections to the one or more autopilot control units;
a wirelessly connected or wire-connected automatic dependent surveillance-broadcast (ADSB) unit providing the software with collision avoidance, traffic, emergency detection and weather information to and from a clean fuel aircraft; and
the one or more autopilot control units or processors configured to compute, select and control, based on one or more algorithms, an amount and distribution of voltage and current from the plurality of hydrogen fuel-cells of the power generation subsystem to each of the plurality of motor and propeller assemblies each comprising a plurality of pairs of propeller blades, and each being electrically connected to and controlled by the plurality of motor controllers, using one or more air-driven turbochargers or superchargers supplying air to the at least one fuel-cell module, and dissipate waste heat using the thermal energy interface subsystem, wherein H₂O molecules are removed using one or more exhaust ports or a vent.

33. The system of claim 31, wherein the display device comprises a primary flight display or avionics display with an arrangement of standard avionics used to monitor and display one or more of operating conditions, control panels, gauges and sensor output for a clean fuel aircraft.

34. The system of claim 31, wherein obtaining current fuel-cell and motor performance data comprises obtaining at least one instrument output or sensor output taken from a listing of outputs measuring one or more of hydrogen temperature, oxygen temperature, fuel temperature, fuel tank temperature, fuel-cell system speed, hydrogen fuel flow, humidity, motor temperature, motor controller temperatures, stack temperatures, coolant temperature, radiator temperature, heat exchanger temperature, battery temperature, exhaust fluid temperature, concentrations of gases in the fuel supply subsystem, fluid pressure, propeller speed (RPM), or outputs of fuel-cell-condition sensors.

35. The system of claim 31, wherein obtaining the current aircraft performance data comprises obtaining at least one instrument output or sensor output taken from a listing of outputs measuring one or more of true airspeed, indicated airspeed, pressure altitude, density altitude, outside air temperature, and vertical speed.

36. The system of claim 31, wherein a third set of a plurality of onboard sensors of the aircraft are linked in a network and sensor outputs from the network are aggregated and processed by an onboard processor or a remote processor to generate a model of the aircraft represented using a primary flight display or avionics display graphical user interface that maintains proportional relationships between graphical representations of sensor elements and other aircraft elements that accurately reflect actual distances and configurations of onboard sensors and aircraft elements.

37. The system of claim 36, wherein the model provides an explorable, interactive three-dimensional digital representation of the aircraft with graphical representations and/or audiovisual representations that augment the model to convey sensor output or output measurements comprising one or more of alpha-numeric symbols, illumination, color changes, flags, highlights or combinations thereof indicating sensor locations to call attention to various occurrences or data related to a set of onboard aircraft sensors or a specific region of the aircraft.

38. The system of claim 37, wherein the model is programed to change display parameters and output when various predetermined aircraft operating states are altered, based on onboard sensor feedback the patterns that emerge across sensor subsets or regions on the model that correspond to actual sensor readings output by the aircraft that are then mapped onto a model display using a remote or onboard processor.

39. The system of claim 37, wherein the model enables representation of data for sensor groupings over time in addition to current sensor output, including display of prior aircraft operating states and changes in data or trend data for comparison to identify regions of the aircraft that are behaving dynamically or diverging from steady state or usual operating parameters.
